(19) United States
(12) Patent Application Publication
(10) Pub. No.: US 2026/0341765 A1
(43) Pub. Date: Oct. 29, 2026

(54) IMPROVED IONOMER BLENDS, HIGH-TEMPERATURE POLYMER ELECTROLYTE MEMBRANES AND ELECTRODE ASSEMBLIES

(71) Applicant: THE PENN STATE RESEARCH FOUNDATION, University Park, PA (US)

(72) Inventors: Christopher George ARGES, University Park, PA (US); Karthik ARUNAGIRI, University Park, PA (US)

(21) Appl. No.: 19/105,585

(22) PCT Filed: Aug. 22, 2023
(86) PCT No.: PCT/US2023/030853

§ 371 Date: Feb. 21, 2025

Related U.S. Application Data
(60) Provisional application No. 63/399,842, filed on Aug. 22, 2022.
(60) Provisional application No. 63/399,849, filed on Aug. 22, 2022.

(51) Int. Cl. H01M 8/1032; C08G 75/23; H01M 8/1044

(52) U.S. Cl. CPC H01M 8/1032; C08G 75/23; H01M 8/1044

(57) ABSTRACT

Disclosed herein are ionomer blends and high temperature polymer electrolyte membranes for use in electrochemical cells. The ionomer blends include a mixture of polyphosphonic acids and polysulfonic acids. The high temperature polymer electrolyte membranes include crosslinked polymeric networks.

### CROSS-REFERENCE TO RELATED APPLICATION

This application claims the benefit of U.S. Provisional Applications 63/399,842, filed Aug. 22, 2022, and 63/399,849, filed Aug. 22, 2022, the contents of which are hereby incorporated in their entirety.

### ACKNOWLEDGEMENT OF GOVERNMENT SUPPORT

This invention was made with government support under Grant No. DE-EE0009101 awarded by the Department of Energy and under Grant No. 2143056 awarded by the National Science Foundation. The government has certain rights in the invention.

### FIELD OF THE DISCLOSURE

The disclosure relates to electrochemical cells and components of same. In an aspect, the disclosure relates to ionomer blends and binders for electrochemical hydrogen pumps. In a further aspect, the disclosure relates to improved high-temperature polymer electrolyte membranes. In a further aspect, the invention relates the improved electrochemical hydrogen pumps and methods of purifying hydrogen using the same.

### BACKGROUND

Hydrogen will play a central role in decarbonizing the global economy in the coming years. About 10% of carbon dioxide (CO₂) emissions hail from steel and ammonia manufacturing. Green hydrogen can be used as an alternative reducing agent in steel manufacturing as opposed to carbon monoxide (CO) derived from fossil fuels. The Haber-Bosch process for ammonia production (for manufacturing fertilizer) utilizes hydrogen produced from steam-reformed natural gas. These are two notable examples of where green hydrogen can be used to clean up hard-to-abate manufacturing sectors of the economy. Furthermore, hydrogen has the potential to be a cost-effective energy storage medium for long-term/seasonal energy storage and the fuel of choice for heavy-duty vehicle (HDV) transport. The energy requirements for HDV transport are commensurate to the range of the vehicle and weight of the vehicle (i.e., fuel cells display higher energy density over battery electric vehicles when the energy requirement exceeds 80 kWh).

Given hydrogen's central role in decarbonization, the U.S. Department of Energy has emphasized an important research goal related to hydrogen: reducing the cost of hydrogen production to $1 per kg of hydrogen within 1 decade. Apart from the production cost for green hydrogen, which hovers around $5 kg⁻¹, another impediment to the widespread proliferation of hydrogen is its delivery and dispensing costs. Various studies highlight that the cost of hydrogen delivery and dispensing are on par with or exceed today's current green hydrogen production costs. Making hydrogen economically appealing for the energy and industrial sectors necessitates a reduction in delivery costs in addition to production costs.

Piped transport is often the most cost-effective way to transport gases. This is one reason why the United States of America has an extensive pipeline for the transport and delivery of natural gas. Building out a new pipeline network for transporting and delivering hydrogen is a timely endeavor, and the timeline for hydrogen adoption in the economy will be fast over the coming decade. Thus, it has been proposed to use the existing natural gas pipeline to transport hydrogen for alleviating hydrogen transport costs and to promote hydrogen adoption. However, there are a myriad of issues that need to be addressed before using the natural gas pipeline for hydrogen storage and delivery. The main issues are the embrittlement of pipeline materials with hydrogen, hydrogen leakage from the pipeline, and the ability to pressure and move hydrogen within the pipeline. The U.S. Department of Energy's Office of Hydrogen and Fuel Cell Technologies Office has created the HyBlend Initiative to examine and address the technical barriers to blend hydrogen in the natural gas pipeline. The embrittlement of pipeline materials with hydrogen is a key issue. This concern is addressed by diluting hydrogen with natural gas to 20% less, preferably 3 to 10%. Hydrogen can be burned along with the blended natural gas when distributed to the endpoints in the pipeline; however, this is not a good use of electrolytically produced green hydrogen. Additionally, many applications that use hydrogen, such as fuel cells and industrial operations, need high purity of hydrogen (i.e., >99% pure) and compression of hydrogen. An electrochemical hydrogen pump (EHP) is a compelling technology for purifying the hydrogen from the natural gas-hydrogen mixture in addition to compressing the purified hydrogen simultaneously. Other methods for hydrogen separation include pressure swing adsorption, and membranes based on palladium and graphenylene, but these separation techniques require a downstream compressor for hydrogen compression.

At the heart of an EHP is a membrane electrode assembly (MEA). The anode in the MEA performs the electrochemical hydrogen oxidation reaction (HOR) that generates two electrons and two protons. The protons migrate across a polymeric proton exchange membrane (PEM) while the electrons generated at the anode move externally through the cell and meet up with the protons and the electrons to recombine at the cathode through an electrochemical reduction reaction (i.e., hydrogen evolution reaction (HER)). The other gas species fed into the anode with the hydrogen do not permeate across the PEM and exit the anode. The purity of the formed hydrogen at the cathode is over 99%. A small amount of the other gas components can seep across the PEM, but engineering the PEM chemistry and making it thicker can mitigate the gas crossover. The PEM separator allows the produced hydrogen at the cathode to be pressurized.

The first generation of EHPs was developed by General Electric that used perfluorosulfonic acid (PFSA) PEMs, and they operated at low temperatures (<100° C.) as the PFSA PEMs need condensed water to mediate proton conductivity. However, the low-temperature operation of EHPs makes them susceptible to irreversible performance loss when contaminants, like carbon monoxide (CO), are present in the feed gas stream because CO poisons the platinum electrocatalyst. Increasing the temperature to 160° C. or greater permits toleration of CO contaminants. High-temperature polymer electrolyte membranes (HT-PEMs) can be used in elevated temperature EHPs as they can provide adequate electrolyte conductivity in the temperature range of 100 to 250° C. without humidification. HT-PEMs often include phosphoric acid-imbibed polybenzimidazole (PBI) or phosphoric acid-imbibed polycations (or polycation/PBI blends).

There remains a need for improved systems and methods for the purification and transportation of hydrogen gas. There remains a need for improved electrochemical hydrogen pumps and improved membrane electrode assemblies for electrochemical hydrogen pumps. There is a need for improved electrode binder materials for the membrane electrode assemblies in an electrochemical hydrogen pump.

### BRIEF DESCRIPTION OF THE FIGURES

FIG. 1 depicts a schematic diagram of an electrochemical hydrogen pump (EHP) and a magnified depiction of an EHP cathode with an electrode ionomer binder illustrating proton and electron transport, the HER reaction, and hydrogen gas transport.

FIG. 2A depicts thin film proton conductivity of ionomer and ionomer blends as a function of temperature: PTFPSA, Nafion™, Aquivion®, and their blends.

FIG. 2B depicts thin film proton conductivity of ionomer and ionomer blends as a function of temperature: PVPA, PVBPA, and their blends with Aquivion®.

FIG. 3A depicts solid state ³¹P NMR spectra of PVPA before and after annealing and a blend of PVPA and Aquivion® after annealing.

FIG. 3B depicts solid state ³¹P NMR spectra of PVBPA before and after annealing and a blend of PVBPA and Aquivion® after annealing.

FIG. 3C depicts solid state ³¹P NMR spectra of PTFSPA before and after annealing and a blend of PTFSPA and Aquivion® after annealing.

FIG. 4 depicts an IDA chamber showing the working of the hydrogen pump on an IDA.

FIG. 5A depicts the polarization curves of IDA hydrogen pump with different ionomers at 200° C.

FIG. 5B depicts a summary of current density at 1 V as a function of temperature for the different thin film ionomers.

FIG. 6A depicts MEA EHP polarization data at T=200° C. with ion-pair HT-PEM, anode and cathode loadings of 1 mg_{Pt} cm⁻² and different electrode ionomer binders (PTFSPA, PVPA, PVBPA with no Aquivion® and blended with Aquivion®).

FIG. 6B depicts EIS of the EHP at T=200° C. with the different ionomer binders in the MEAs with a DC bias of 0.05V.

FIG. 6C depicts the charge transfer coefficient (R_{ct}) extracted from EIS with DC bias of 0.05V.

FIG. 6D depicts EIS of the EHP at T=200° C. with the different ionomer binders in the MEAs with a DC bias of 0.75 V.

FIG. 6E depicts a Warburg plot showing the diffusion resistance (a) calculated from the Nyquist plots for MEAs with the different ionomer binders.

FIG. 7A depicts the thin film conductivity of PTFSPA-Aquivion® blend at different P/S ratios.

FIG. 7B depicts the thin film conductivity of PVPA-Aquivion® blend at different P/S ratios.

FIG. 7C depicts a thin-film coated IDA and IDA in the chamber.

FIG. 7D depicts the thin film conductivity of PTFSPA, Aquivion®, and Nafion™ as a function of % RH at room temperature.

FIG. 8A depicts polarization curves for EHP on IDAs with nanoscale Pt and thin films of PTFSPA, PVPA, PVBPA, and the phosphonic acid ionomers blended with Aquivion® at 160° C.

FIG. 8B depicts polarization curves for EHP on IDAs with nanoscale Pt and thin films of PTFSPA, PVPA, PVBPA, and the phosphonic acid ionomers blended with Aquivion® at 120° C.

FIG. 8C depicts polarization curves for EHP on IDAs with nanoscale Pt and thin films of PTFSPA-Aquivion® blend at different P/S ratios.

FIG. 9A depicts MEA EHP polarization data and EIS with DC bias of 0.05 V at T=120° C. with ion-pair HT-PEM, anode, and cathode loadings of 1 mg_{Pt} cm⁻² and different electrode ionomer binders (PTFSPA, PVPA, PVBPA with no Aquivion® and blended with Aquivion®.

FIG. 9B depicts MEA EHP polarization data and EIS with DC bias of 0.05 V at T=160° C. with ion-pair HT-PEM, anode, and cathode loadings of 1 mg_{Pt} cm² and different electrode ionomer binders (PTFSPA, PVPA, PVBPA with no Aquivion® and blended with Aquivion®.

FIG. 10 depicts charge transfer resistance (R_{ct}) obtained from EIS in FIGS. 9A (left panel) and 9B (right panel).

FIG. 11 depicts polarization curves for hydrogen purification from hydrogen-natural gas mixtures.

FIG. 12 depicts a polarization curve hydrogen purification from hydrogen-natural gas mixtures with backpressure applied to the cathode and/or anode.

FIG. 13 depicts the durability of the test cells over 100 hours for purifying hydrogen from a 10% hydrogen natural gas mixture.

FIG. 14 depicts the ionic conductivity of a crosslinked polysulfone blended with polybenzimidazole and imbibed with H₃PO₄.

FIG. 15 depicts the ionic conductivity of a polybenzimidazole crosslinked with polyvinyl benzyl chloride and imbibed with H₃PO₄.

FIG. 16 depicts the ionic conductivity of a polybenzimidazole crosslinked with polyvinyl benzyl chloride and imbibed with methyl phosphonic acid or ethyl phosphonic acid.

FIG. 17 depicts the ionic conductivity of a depicts the ionic conductivity of a crosslinked polysulfone blended with polybenzimidazole and imbibed with methyl phosphonic acid or ethyl phosphonic acid.

FIG. 18 depicts an idealized chemical structure for a network composed of a crosslinked polysulfone blended with polybenzimidazole.

### DETAILED DESCRIPTION

Before the present methods and systems are disclosed and described, it is to be understood that the methods and systems are not limited to specific synthetic methods, specific components, or to particular compositions. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes, from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The term “alkyl” refers to a radical of a straight-chain or branched hydrocarbon group having a specified range of carbon atoms (e.g., a “C₁₋₁₆ alkyl” can have from 1 to 16 carbon atoms). An alkyl group can be saturated or unsaturated, i.e., an alkenyl or alkynyl group. Unless specified to the contrary, an “alkyl” group includes both saturated alkyl groups and unsaturated alkyl groups.

When a range of values is listed, it is intended to encompass each value and sub-range within the range. For example, “C₁₋₆ alkyl” is intended to encompass C₁, C₂, C₃, C₄, C₅, C₆, C₁₋₆, C₁₋₅, C₁₋₄, C₁₋₃, C₁₋₂, C₂₋₆, C₂₋₅, C₂₋₄, C₂₋₃, C₃₋₆, C₃₋₅, C₃₋₄, C₄₋₆, C₄₋₅, and C₅₋₆ alkyl.

The term “alkoxy” refers to an alkyl group, as defined herein, appended to the parent molecular moiety through an oxygen atom.

The term “heteroalkyl” refers to an alkyl group, which further includes at least one heteroatom (e.g., 1, 2, 3, or 4 heteroatoms) selected from oxygen, nitrogen, or sulfur within (i.e., inserted between adjacent carbon atoms of) and/or placed at one or more terminal position(s) of the parent chain. By way of example, a C₁₋₆ heteroalkyl) group includes, but is not limited to, the following structures:

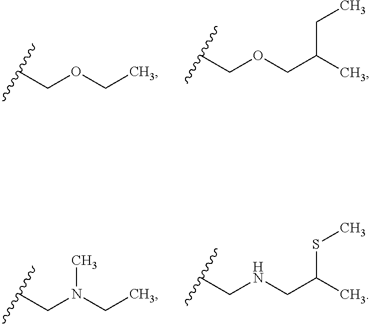

The term “heteroalkyl” preceded by a separate heteroatom refers to a heteroalkyl group bonded through the specified heteroatom. By way of example, a OC₁₋₆ heteroalkyl group includes, but it not limited to, the following structures:

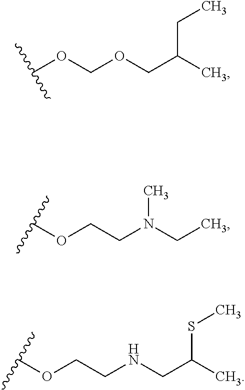

The term “carbocyclyl,” “cycloalkyl,” or “carbocyclic” refers to a radical of a non-aromatic cyclic hydrocarbon group. A carbocyclyl group can either be monocyclic (“monocyclic carbocyclyl”) or polycyclic (e.g., a fused, bridged or spiro ring system such as a bicyclic system (“bicyclic carbocyclyl”) or tricyclic system (“tricyclic carbocyclyl”)), and can be saturated or can contain one or more carbon-carbon double or triple bonds.

The term “heterocyclyl” refers to a ring system that includes at least one heteroatom in the cycle. A heterocyclyl group can either be monocyclic (“monocyclic heterocyclyl”) or polycyclic (e.g., a fused, bridged or spiro ring system such as a bicyclic system (“bicyclic heterocyclyl”) or tricyclic system (“tricyclic heterocyclyl”)), and can be saturated or can contain one or more carbon-carbon double or triple bonds. Heterocyclyl polycyclic ring systems can include one or more heteroatoms in one or both rings. “Heterocyclyl” also includes ring systems wherein the heterocyclyl ring, as defined above, is fused with one or more carbocyclyl groups wherein the point of attachment is either on the carbocyclyl or heterocyclyl ring, or ring systems wherein the heterocyclyl ring, as defined above, is fused with one or more aryl or heteroaryl groups, wherein the point of attachment is on the heterocyclyl ring, and in such instances, the number of ring members continue to designate the number of ring members in the heterocyclyl ring system. Unless otherwise specified, each instance of heterocyclyl is independently unsubstituted (an “unsubstituted heterocyclyl”) or substituted (a “substituted heterocyclyl”) with one or more substituents.

The term “aryl” refers to a radical of a monocyclic or polycyclic (e.g., bicyclic or tricyclic) 4n+2 aromatic ring system (e.g., having 6, 10, or 14 π electrons shared in a cyclic array) having 6-14 ring carbon atoms and zero heteroatoms provided in the aromatic ring system (“C₆₋₁₄ aryl”). “Aryl” also includes ring systems wherein the aryl ring, as defined above, is fused with one or more carbocyclyl or heterocyclyl groups wherein the radical or point of attachment is on the aryl ring, and in such instances, the number of carbon atoms continue to designate the number of carbon atoms in the aryl ring system. Unless otherwise specified, each instance of an aryl group is independently unsubstituted (an “unsubstituted aryl”) or substituted (a “substituted aryl”) with one or more substituents.

“Aralkyl” is a subset of “alkyl” and refers to an alkyl group substituted by an aryl group, wherein the point of attachment is on the alkyl moiety.

The term “heteroaryl” refers to a radical of a 5-14 membered monocyclic or polycyclic (e.g., bicyclic, tricyclic) 4n+2 aromatic ring system (e.g., having 6, 10, or 14 Ti electrons shared in a cyclic array) having ring carbon atoms and 1-4 ring heteroatoms provided in the aromatic ring system, wherein each heteroatom is independently selected from nitrogen, oxygen, and sulfur (“5-14 membered heteroaryl”). In heteroaryl groups that contain one or more nitrogen atoms, the point of attachment can be a carbon or nitrogen atom, as valency permits. Heteroaryl polycyclic ring systems can include one or more heteroatoms in one or both rings. “Heteroaryl” includes ring systems wherein the heteroaryl ring, as defined above, is fused with one or more carbocyclyl or heterocyclyl groups wherein the point of attachment is on the heteroaryl ring, and in such instances, the number of ring members continue to designate the number of ring members in the heteroaryl ring system. “Heteroaryl” also includes ring systems wherein the heteroaryl ring, as defined above, is fused with one or more aryl groups wherein the point of attachment is either on the aryl or heteroaryl ring, and in such instances, the number of ring members designates the number of ring members in the fused polycyclic (aryl/heteroaryl) ring system. Polycyclic heteroaryl groups wherein one ring does not contain a heteroatom (e.g., indolyl, quinolinyl, carbazolyl, and the like) the point of attachment can be on either ring, i.e., either the ring bearing a heteroatom (e.g., 2-indolyl) or the ring that does not contain a heteroatom (e.g., 5-indolyl).

### Ionomer Blends

Disclosed herein are ionomer blends including a polysulfonic acid of Formula (1):

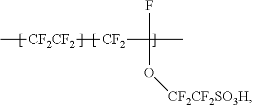

and a polyphosphonic acid.

The polysulfonic acid is a random copolymer, typically capped with a carboxylic acid, an additional CF₃ group, or fluorine atom at each end. The relative ratios of the sulfonated monomer unit and tetrafluoroethylene monomer units can be expressed by equivalent weight (“EW”) which is the inverse of the ion-exchange capacity. Thus, a lower equivalent weight will indicate a higher percentage of sulfonic acid units. A similar formula may be used to characterize the polyphosphonic acid, wherein the polyphosphonic acid is composed of phosphonic acid-containing repeat units and non-phosphonic acid containing repeat units.

In certain implementations, the polyphosphonic acid is polyvinylphosphonic acid, poly(pentafluorostyrene-co-tetrafluorostyrene-phosphonic acid), poly(vinyl benzyl phosphonic acid), poly(styrene-phosphonic acid), or a combination thereof. In certain preferred implementations, the polyphosphonic acid is poly(pentafluorostyrene-co-tetrafluorostyrene-phosphonic acid).

In certain implementations, the polysulfonic acid of Formula (1) can have an equivalent weight from 275 to 1,500 g/mol, from 275-1,000 g/mol, from 275-750 g/mol, from 275-500 g/mol, from 500-1,500 g/mol, from 750-1,500 g/mol, from 1,000-1,500 g/mol, from 1,250-1,500 g/mol, from 500-750 g/mol, from 750-1,000 g/mol, or from 1,000-1,250 g/mol.

In some implementations, the polysulfonic acid of Formula (1) can have an ion exchange capacity from 0.1-5 mmol/g, from 0.5-2.5 mmol/g, from 0.5-2.5 mmol/g, or from 0.75-1.25 mmol/g.

In certain implementations, the polyphosphonic acid has an equivalent weight from 275 to 1200 g/mol, from 275-1,000 g/mol, from 275-750 g/mol, from 275-500 g/mol, from 500-1,200 g/mol, from 750-1,200 g/mol, from 1,000-1,200 g/mol, from 500-750 g/mol, from 750-1,000 g/mol, or from 1,000-1.20 g/mol.

In some implementations, the polyphosphonic acid can have an ion exchange capacity from 1-20 mmol/g, from 1-10 mmol/g, from 1-5 mmol/g, from 1-2.5 mmol/g, from 2.5-5 mmol/g, from 5-10 mmol/g, or from 10-20 mmol/g.

The ionomer blend may be further characterized by relative amounts of phosphonic acid groups and sulfonic acid groups. In certain implementations, the molar ratio of phosphoric acid groups to sulfonic acid groups is from 10:1 to 1:10, from 10:1 to 5:1, from 10:1 to 1:1, from 5:1 to 1:5, from 5:1 to 2.5:1, from 5:1 to 1:1, from 2.5:1 to 1:2.5, from 2.5:1 to 1:1, from 1:1 to 1:2.5, from 1:1 to 1:5, from 1:2.5 to 1:5, from 1:1 to 1:10, or from 1:5 to 1:10.

Also disclosed herein are ionomer blends including a polysulfonic acid of Formula (2a), Formula (2b), Formula (2c), or a combination thereof:

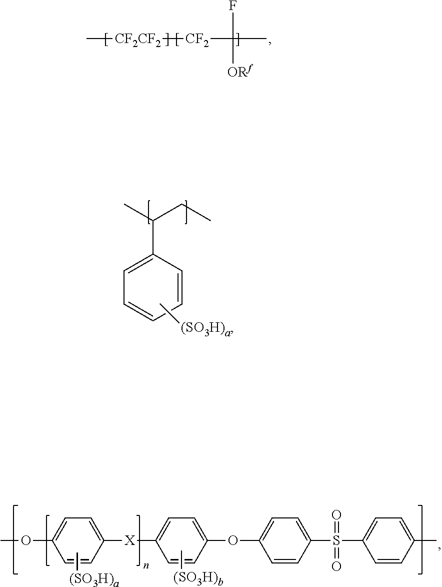

wherein
R^{f} has the formula —CF₂CF₂SO₃H or —CF₂CF₂OCF₂CF₂SO₃H;
X is selected from null, O, C(CH₃)₂, or C(CF₃)₂;
n is 0 or 1; and
a and b are in each case independently selected from 0, 1, 2, 3, or 4, preferably 0, 1, or 2, more preferably 0 or 1, and
a polyphosphonic acid selected from polyvinylphosphonic acid, poly(vinyl benzyl phosphonic acid), and poly(styrene-4-phosphonic acid).

In some implementations, the ionomer blend can include the polysulfonic acid of Formula (2a), wherein R^{f} has the formula —CF₂CF₂OCF₂CF₂SO₃H, which may be designated Formula (2a-1). In certain implementations, the ionomer blend can include the polysulfonic acid of Formula (2a-1), and can have an equivalent weight from 275 to 1,500 g/mol, from 275-1,000 g/mol, from 275-750 g/mol, from 275-500 g/mol, from 500-1,500 g/mol, from 750-1,500 g/mol, from 1,000-1,500 g/mol, from 1,250-1,500 g/mol, from 500-750 g/mol, from 750-1,000 g/mol, or from 1,000-1,250 g/mol.

The ionomer blend may be further characterized by relative amounts of phosphonic acid groups and sulfonic acid groups in the polysulfonic acid of Formula (2a-1). In certain implementations, the molar ratio of phosphoric acid groups to sulfonic acid groups is from 10:1 to 1:10, from 10:1 to 5:1, from 10:1 to 1:1, from 5:1 to 1:5, from 5:1 to 2.5:1, from 5:1 to 1:1, from 2.5:1 to 1:2.5, from 2.5:1 to 1:1, from 1:1 to 1:2.5, from 1:1 to 1:5, from 1:2.5 to 1:5, from 1:1 to 1:10, or from 1:5 to 1:10.

In some implementations, the ionomer blend can include the polysulfonic acid of Formula (2a), wherein R^{f} has the formula —CF₂CF₂OCF₂CF₂SO₃H, which may be designated Formula (2a-1). In some implementations the polysulfonic acid of Formula (2a-1) can have an ion exchange capacity from 0.1-5 mmol/g, from 0.5-2.5 mmol/g, from 0.5-2.5 mmol/g, or from 0.75-1.25 mmol/g.

In some implementations, the ionomer blend can include the polysulfonic acid of Formula (2a-1) and polyvinylphosphonic acid. The polyvinyl phosphonic acid can an equivalent weight from 275 to 1200 g/mol, from 275-1,000 g/mol, from 275-750 g/mol, from 275-500 g/mol, from 500-1,200 g/mol, from 750-1,200 g/mol, from 1,000-1,200 g/mol, from 500-750 g/mol, from 750-1,000 g/mol, or from 1,000-1.20 g/mol.

In some implementations, the ionomer blend can include the polysulfonic acid of Formula (2a-1) and polyvinylphosphonic acid. The polyvinyl phosphonic acid can have an ion exchange capacity from 1-20 mmol/g, from 1-10 mmol/g, from 1-5 mmol/g, from 1-2.5 mmol/g, from 2.5-5 mmol/g, from 5-10 mmol/g, or from 10-20 mmol/g.

In some implementations, the ionomer blend can include the polysulfonic acid of Formula (2a-1) and poly(vinyl benzyl phosphonic acid). The poly(vinyl benzyl phosphonic acid) can an equivalent weight from 275 to 1200 g/mol, from 275-1,000 g/mol, from 275-750 g/mol, from 275-500 g/mol, from 500-1,200 g/mol, from 750-1,200 g/mol, from 1,000-1,200 g/mol, from 500-750 g/mol, from 750-1,000 g/mol, or from 1,000-1.20 g/mol.

In some implementations, the ionomer blend can include the polysulfonic acid of Formula (2a-1) and poly(vinyl benzyl phosphonic acid). The poly(vinyl benzyl phosphonic acid) can have an ion exchange capacity from 1-20 mmol/g, from 1-10 mmol/g, from 1-5 mmol/g, from 1-2.5 mmol/g, from 2.5-5 mmol/g, from 5-10 mmol/g, or from 10-20 mmol/g.

In some implementations, the ionomer blend can include the polysulfonic acid of Formula (2a-1) and poly(styrene-4-phosphonic acid). The poly(styrene-4-phosphonic acid) can an equivalent weight from 275 to 1200 g/mol, from 275-1,000 g/mol, from 275-750 g/mol, from 275-500 g/mol, from 500-1,200 g/mol, from 750-1,200 g/mol, from 1,000-1,200 g/mol, from 500-750 g/mol, from 750-1,000 g/mol, or from 1,000-1.20 g/mol.

In some implementations, the ionomer blend can include the polysulfonic acid of Formula (2a-1) and poly(styrene-4-phosphonic acid). The poly(styrene-4-phosphonic acid) can have an ion exchange capacity from 1-20 mmol/g, from 1-10 mmol/g, from 1-5 mmol/g, from 1-2.5 mmol/g, from 2.5-5 mmol/g, from 5-10 mmol/g, or from 10-20 mmol/g.

In some implementations, the ionomer blend can include the polysulfonic acid of Formula (2b). In certain implementations, the ionomer blend can include the polysulfonic acid of Formula (2b), and can have an equivalent weight from 275 to 1,500 g/mol, from 275-1,000 g/mol, from 275-750 g/mol, from 275-500 g/mol, from 500-1,500 g/mol, from 750-1,500 g/mol, from 1,000-1,500 g/mol, from 1,250-1,500 g/mol, from 500-750 g/mol, from 750-1,000 g/mol, or from 1,000-1,250 g/mol.

The ionomer blend may be further characterized by relative amounts of phosphonic acid groups and sulfonic acid groups in the polysulfonic acid of Formula (2b). In certain implementations, the molar ratio of phosphoric acid groups to sulfonic acid groups is from 10:1 to 1:10, from 10:1 to 5:1, from 10:1 to 1:1, from 5:1 to 1:5, from 5:1 to 2.5:1, from 5:1 to 1:1, from 2.5:1 to 1:2.5, from 2.5:1 to 1:1, from 1:1 to 1:2.5, from 1:1 to 1:5, from 1:2.5 to 1:5, from 1:1 to 1:10, or from 1:5 to 1:10.

In some implementations, the ionomer blend can include the polysulfonic acid of Formula (2b). In some implementations the polysulfonic acid of Formula (2b) can have an ion exchange capacity from 0.1-5 mmol/g, from 0.5-2.5 mmol/g, from 0.5-2.5 mmol/g, or from 0.75-1.25 mmol/g.

In some implementations, the ionomer blend can include the polysulfonic acid of Formula (2b) and polyvinylphosphonic acid. The polyvinyl phosphonic acid can an equivalent weight from 275 to 1200 g/mol, from 275-1,000 g/mol, from 275-750 g/mol, from 275-500 g/mol, from 500-1,200 g/mol, from 750-1,200 g/mol, from 1,000-1,200 g/mol, from 500-750 g/mol, from 750-1,000 g/mol, or from 1,000-1.20 g/mol.

In some implementations, the ionomer blend can include the polysulfonic acid of Formula (2b) and polyvinylphosphonic acid. The polyvinyl phosphonic acid can have an ion exchange capacity from 1-20 mmol/g, from 1-10 mmol/g, from 1-5 mmol/g, from 1-2.5 mmol/g, from 2.5-5 mmol/g, from 5-10 mmol/g, or from 10-20 mmol/g.

In some implementations, the ionomer blend can include the polysulfonic acid of Formula (2b) and poly(vinyl benzyl phosphonic acid). The poly(vinyl benzyl phosphonic acid) can an equivalent weight from 275 to 1200 g/mol, from 275-1,000 g/mol, from 275-750 g/mol, from 275-500 g/mol, from 500-1,200 g/mol, from 750-1,200 g/mol, from 1,000-1,200 g/mol, from 500-750 g/mol, from 750-1,000 g/mol, or from 1,000-1.20 g/mol.

In some implementations, the ionomer blend can include the polysulfonic acid of Formula (2b) and poly(vinyl benzyl phosphonic acid). The poly(vinyl benzyl phosphonic acid) can have an ion exchange capacity from 1-20 mmol/g, from 1-10 mmol/g, from 1-5 mmol/g, from 1-2.5 mmol/g, from 2.5-5 mmol/g, from 5-10 mmol/g, or from 10-20 mmol/g.

In some implementations, the ionomer blend can include the polysulfonic acid of Formula (2b) and poly(styrene-4-phosphonic acid). The poly(styrene-4-phosphonic acid) can an equivalent weight from 275 to 1200 g/mol, from 275-1,000 g/mol, from 275-750 g/mol, from 275-500 g/mol, from 500-1,200 g/mol, from 750-1,200 g/mol, from 1,000-1,200 g/mol, from 500-750 g/mol, from 750-1,000 g/mol, or from 1,000-1.20 g/mol.

In some implementations, the ionomer blend can include the polysulfonic acid of Formula (2b) and poly(styrene-4-phosphonic acid). The poly(styrene-4-phosphonic acid) can have an ion exchange capacity from 1-20 mmol/g, from 1-10 mmol/g, from 1-5 mmol/g, from 1-2.5 mmol/g, from 2.5-5 mmol/g, from 5-10 mmol/g, or from 10-20 mmol/g.

In some implementations, the ionomer blend can include the polysulfonic acid of Formula (2c). In preferred implementations of the polysulfonic acid of Formula (2c), n is 1 and X is either null or is C(CH₃)₂. In certain implementations, the ionomer blend can include the polysulfonic acid of Formula (2c), and can have an equivalent weight from 275 to 1,500 g/mol, from 275-1,000 g/mol, from 275-750 g/mol, from 275-500 g/mol, from 500-1,500 g/mol, from 750-1,500 g/mol, from 1,000-1,500 g/mol, from 1,250-1,500 g/mol, from 500-750 g/mol, from 750-1,000 g/mol, or from 1,000-1,250 g/mol.

The ionomer blend may be further characterized by relative amounts of phosphonic acid groups and sulfonic acid groups in the polysulfonic acid of Formula (2c). In certain implementations, the molar ratio of phosphoric acid groups to sulfonic acid groups is from 10:1 to 1:10, from 10:1 to 5:1, from 10:1 to 1:1, from 5:1 to 1:5, from 5:1 to 2.5:1, from 5:1 to 1:1, from 2.5:1 to 1:2.5, from 2.5:1 to 1:1, from 1:1 to 1:2.5, from 1:1 to 1:5, from 1:2.5 to 1:5, from 1:1 to 1:10, or from 1:5 to 1:10.

In some implementations, the ionomer blend can include the polysulfonic acid of Formula (2c). In some implementations the polysulfonic acid of Formula (2c) can have an ion exchange capacity from 0.1-5 mmol/g, from 0.5-2.5 mmol/g, from 0.5-2.5 mmol/g, or from 0.75-1.25 mmol/g.

In some implementations, the ionomer blend can include the polysulfonic acid of Formula (2c) and polyvinylphosphonic acid. The polyvinyl phosphonic acid can an equivalent weight from 275 to 1200 g/mol, from 275-1,000 g/mol, from 275-750 g/mol, from 275-500 g/mol, from 500-1,200 g/mol, from 750-1,200 g/mol, from 1,000-1,200 g/mol, from 500-750 g/mol, from 750-1,000 g/mol, or from 1,000-1.20 g/mol.

In some implementations, the ionomer blend can include the polysulfonic acid of Formula (2c) and polyvinylphosphonic acid. The polyvinyl phosphonic acid can have an ion exchange capacity from 1-20 mmol/g, from 1-10 mmol/g, from 1-5 mmol/g, from 1-2.5 mmol/g, from 2.5-5 mmol/g, from 5-10 mmol/g, or from 10-20 mmol/g.

In some implementations, the ionomer blend can include the polysulfonic acid of Formula (2c) and poly(vinyl benzyl phosphonic acid). The poly(vinyl benzyl phosphonic acid) can an equivalent weight from 275 to 1200 g/mol, from 275-1,000 g/mol, from 275-750 g/mol, from 275-500 g/mol, from 500-1,200 g/mol, from 750-1,200 g/mol, from 1,000-1,200 g/mol, from 500-750 g/mol, from 750-1,000 g/mol, or from 1,000-1.20 g/mol.

In some implementations, the ionomer blend can include the polysulfonic acid of Formula (2c) and poly(vinyl benzyl phosphonic acid). The poly(vinyl benzyl phosphonic acid) can have an ion exchange capacity from 1-20 mmol/g, from 1-10 mmol/g, from 1-5 mmol/g, from 1-2.5 mmol/g, from 2.5-5 mmol/g, from 5-10 mmol/g, or from 10-20 mmol/g.

In some implementations, the ionomer blend can include the polysulfonic acid of Formula (2c) and poly(styrene-4-phosphonic acid). The poly(styrene-4-phosphonic acid) can an equivalent weight from 275 to 1200 g/mol, from 275-1,000 g/mol, from 275-750 g/mol, from 275-500 g/mol, from 500-1,200 g/mol, from 750-1,200 g/mol, from 1,000-1,200 g/mol, from 500-750 g/mol, from 750-1,000 g/mol, or from 1,000-1.20 g/mol.

In some implementations, the ionomer blend can include the polysulfonic acid of Formula (2c) and poly(styrene-4-phosphonic acid). The poly(styrene-4-phosphonic acid) can have an ion exchange capacity from 1-20 mmol/g, from 1-10 mmol/g, from 1-5 mmol/g, from 1-2.5 mmol/g, from 2.5-5 mmol/g, from 5-10 mmol/g, or from 10-20 mmol/g.

In certain implementations, the disclosed ionomer blends may further include an ionic liquid (i.e., an ionic salt that is in the liquid state). In certain implementations the ionic liquid is a salt with a melting point not greater than 100° C. In certain implementations, the ionomer blend may include an ionic liquid in an amount from 0.1 to 10 wt. % of the ionomer-ionic liquid blend.

In certain implementations, the ionic liquid is a 1-alkyl-3-methylimidazolium salt, for example a 1-alkyl-3-methylimidazolium paired with an anion selected from tetrafluoroborate, hexafluorophosphate, bis-trifluoromethanesulfonimide, trifluoromethanesulfonate, dicyanamide, hydrogen sulfate, methyl sulfate, and ethyl sulfate. In some implementations the ionic liquid is a 1-alkyl-3-methylimidazolium bis-trifluoromethanesulfonimide salt.

In some implementations the ionic liquid is a bis-trifluoromethanesulfonimide salt of 1-ethyl-3-methylimidazolium, 1-butyl-3-methylimidazolium, 1-butyl-2,3-dimethylimidazolium, 1-octyl-3 methylimidazolium, 1-decyl-3-methylimidazolium, or 1-dodecyl-3-methyldodecyl imidazolium. In certain preferred implementations, the ionic liquid is a bis-trifluoromethanesulfonimide salt of 1-ethyl-3-methylimidazolium, 1-butyl-3-methylimidazolium, 1-butyl-2,3-dimethylimidazolium.

### Binder Products

Also disclosed herein are binder products including an ionomer blend according to the disclosure. In certain implementations the binder product includes an ionomer blend and a solvent, optionally in further combination with an ionic liquid. The ionomer blend may be present in the binder product in an amount from 0.1-20 wt. %, from 0.1-10 wt. %, from 0.1-5 wt. %, from 1-5 wt. %, from 2.5-7.5 wt. %, from 5-10 wt. %, or from 10-20 wt. %.

In certain implementations, the binder product includes an ethereal solvent (including, but not limited to, tetrahydrofuran, diethyl ether, dimethoxyethane, 1,4 dioxane), a C₁₋₄ alcohol (including, but not limited to, methanol, ethanol, isopropanol, n-propanol, n-butanol, isobutanol, tert-butanol), dimethyl sulfoxide, N,N-dimethylacetamide, N,N-dimethylformamide, N-methyl-2-pyrrolidone, and combinations thereof.

### Electrodes

Also disclosed herein are electrodes including the disclosed ionomer blends. In some implementations the electrode includes, in addition to the ionomer blend, a porous carbonaceous material and a catalyst.

In some implementations, the carbonaceous material can include carbon paper, carbon fibers, carbon black, graphene, graphite, carbon nanotubes, buckyballs, or a combination thereof.

In certain implementations, the electrode can include the ionomer blend (optionally with ionic liquid) in an amount of from 2-25 wt. %, from 5-25 wt. %, from 5-15 wt. %, from 5-10 wt. %, from 7.5-12.5 wt. %, or from 10-15 wt. %.

In some implementations, the catalyst may include particles containing both the active catalyst and a support, for example carbon particles. In certain implementations the active catalyst includes one or more transition metals or alloy thereof. In certain implementations the catalyst includes one or more precious metals or alloy thereof. In certain implementations the catalyst is a precious metal selected from platinum, palladium, iridium, gold, silver, an alloy thereof, or a combination thereof. In certain implementations the catalyst includes one of the aforementioned precious metals alloyed with a transition metal. In some implementations the metal is platinum. Exemplary alloys include PtCo and PtNi. In some implementations, the electrode can include catalyst is an amount from 0.1-10 mg metal/cm². In some implementations the electrode can catalyst is an amount from 0.1-5 mg metal/cm², from 0.1-2.5 mg metal/cm², from 0.1-1.5 mg metal/cm², from 0.5-2.5 mg metal/cm², from 1-2.5 mg metal/cm², or from 1-5 mg metal/cm².

### Crosslinked Networks

Disclosed herein are crosslinked polysulfone networks having the formula:

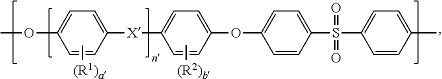

wherein
X′ is selected from null, O, C(═O), C(CH₃)₂, or C(CF₃)₂;
N′ is 0 or 1;
a′ and b′ are in each case independently selected from 0, 1, 2, 3, or 4;
R¹ and R² are in each case methylene substituted by halo, preferably chloro, or a cationic nitrogen group, for example, N(C₁₋₆ alkyl)₃, N-heterocyclyl, or N-heteroaryl,
wherein at least one R¹ or R² group comprises a cationic nitrogen group;
wherein at least one R¹ or R² group is a crosslinking group covalently bonded to a separate polysulfone monomer unit.

As used herein, the separate polysulfone monomer unit may occur in separate polysulfone polymer chain, or the polysulfone may be crosslinked to itself, i.e.:

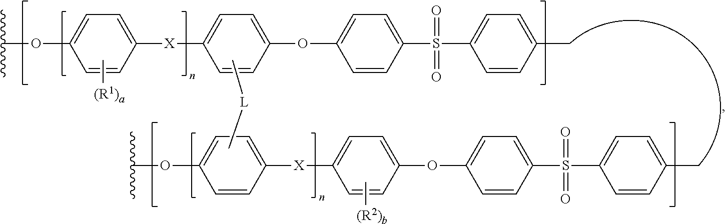

wherein L represents a linker and the curved line represents an arbitrary number of polysulfone repeat units. In the above non-limiting example, the R² substituent is the crosslinking group in one monomer unit, while the R¹ substituent is the crosslinking group in the second monomer unit. In other implementations, two different R¹ groups, or two different R² groups may be crosslinked together. The skilled person appreciates that the crosslinked polysulfone will include any or all of the possible combinations.

As used herein, N-heteroaryl refers to substituents having the general formula:

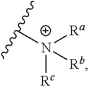

wherein R^{a}, R^{b}, and R^{c} together form an aromatic system. Exemplary N-heteroaryl groups include:

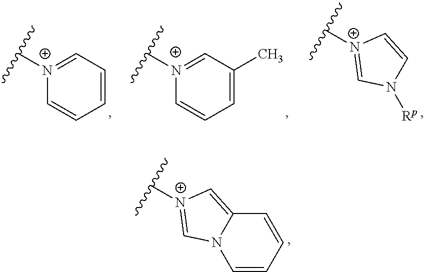

wherein R^{p} is a non-hydrogen substituent, preferably a C₁₋₃ alkyl group.

As used herein, N-heterocyclyl refers to substituents having the general formula:

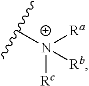

wherein none of R^{a}, R^{b}, and R^{c} are hydrogen, and at least two of R^{a}, R^{b}, and R^{c} together form a non-aromatic ring. Exemplary N-heterocyclyl groups include:

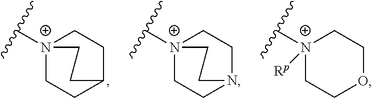

wherein R^{p} is a non-hydrogen substituent, preferably a C₁₋₃ alkyl group.

In some implementations one R¹ or R² is a methylene group substituted by N(C₁₋₆ alkyl)₃, where the C₁₋₆ alkyl groups are in each case independently selected from methyl, ethyl, and isopropyl.

In some implementations, one of R¹ or R² has the formula:

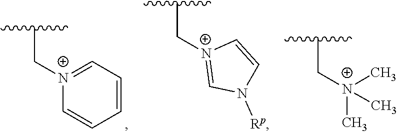

wherein
R^{P} is a C₁₋₃ alkyl group.

In some implementations, the crosslinked polysulfone network is crosslinked by a group having the formula:

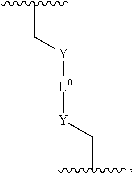

wherein L⁰ is null or C₁₋₁₂ alkylene, and Y is in each case independently selected from O, S, NH₂, HN(C₁₋₃ alkyl), N(C₁₋₃ alkyl)₂, heterocyclyl, or heteroaryl. In some implementations, Y is O, [NH₂]⁺, [NH(CH₃)]⁺, or [N(CH₃)₂]⁺.

In some implementations one of R¹ or R² is a group having the formula:

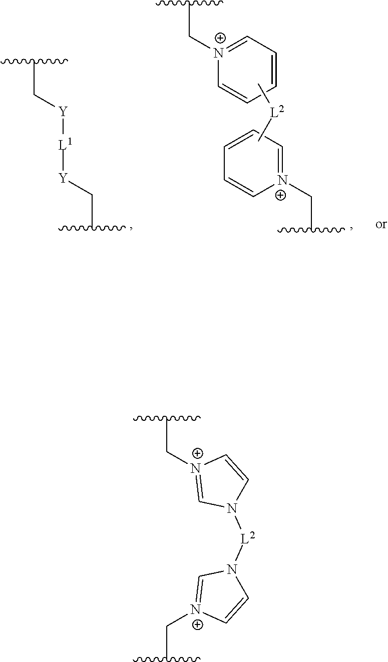

wherein L¹ is a C₂₋₁₂ alkylene group and L₂ is null or a C₁₋₁₂ alkylene group; and
Y is O, NH₂, NH(CH₃), or N(CH₃)₂.

In some implementations, at least one of R¹ or R² is a group having the formula:

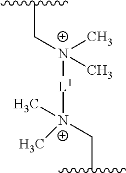

wherein L¹ is CH₂CH₂, CH₂CH₂CH₂, CH₂CH₂CH₂CH₂, CH₂CH₂CH₂CH₂CH₂, CH₂CH₂CH₂CH₂CH₂CH₂, CH₂CH₂CH₂CH₂CH₂CH₂CH₂, or CH₂CH₂CH₂CH₂CH₂CH₂CH₂CH₂.

In some implementations, the crosslinked polysulfone network may be characterized by an average a′+b′ value. The number represents the degree of substitution on the core polysulfone. An a′+b′ value of 8 would indicate that every aryl ring not directly bonded to the sulfone was completely substituted. An a′+b′ value of 0 would indicate that those same aryl rings did not contain any substituents. The skilled person understands that along the entire polysulfone backbone, individual aryl rings may not be substituted, while others may be substituted by two or more substituents. In some implementations, the average a′+b′ value can be from 0.8-2.2, from 0.8-1.2, from 1.0-2.2, from 1.0-2.0, from 1.0-1.8, from 1.0-1.5, from 1.0-1.2, from 1.2-1.6, from 1.4-1.8, from 1.5-2.0, from 1.6-2.0, from 1.6-2.2, or from 1.6-1.8, from 1.8-2.2, from 1.8-2.0, or from 2.0-2.2. Average a′+b′ values may be determined using NMR spectroscopy and/or chemical analysis.

In some implementations, the crosslinked polysulfone network may be characterized by the percentage of crosslinking groups present in the crosslinked polysulfone. In certain implementations, the crosslinking groups are present in an amount from 1%-20%. That is, 1%-20% of the R¹ and R² groups present in the polysulfone are a crosslinking group. In other implementations, the crosslinking groups are present in an amount from 1%-10%, from 1%-5%, from 2.5%-7.5%, from 5%-10%, from 5%-15%, or from 10-20%.

In some implementations, R¹ and R² are independently selected from:

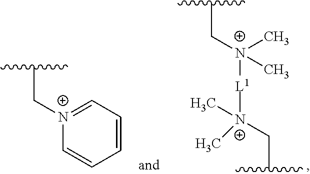

wherein L¹ is CH₂CH₂CH₂CH₂, CH₂CH₂CH₂CH₂CH₂, CH₂CH₂CH₂CH₂CH₂CH₂, or CH₂CH₂CH₂CH₂CH₂CH₂CH₂.

The crosslinked polysulfone network may be prepared by first combining a chloromethylated polysulfone with a crosslinking agent. Chloromethylated polysulfone may be obtained by Friedel Craft reaction with an unfunctionalized polysulfone. In some instances a polysulfone may be combined with paraformaldehyde, chlorotrimethylsilane, and a Lewis acid catalyst. The polysulfone may have a MW from 5-250 kDa, from 10-250 kDa, from 10-200 kDa, from 10-150 kDa, from 10-100 kDa, from 10-50 kDa, from 5-15 kDa, from 5-25 kDa, from 5-50 kDa, from 25-100 kDa, from 50-125 kDa, from 85-150 kDa, or from 100-250 kDa. The number of chloromethylene groups installed in each repeating unit is designated the degree of functionalization (DF), and may be measured by NMR spectroscopy. The DF may be controlled by reaction time and/or the stoichiometry of the chloromethylating reagents. In certain implementations, the chloromethylated polysulfone can have a degree of functionalization from 0.5-2.0, from 0.5-1.5, from 0.5-1.25, from 0.75-1.25, from 1.0-1.25, or from 1.1-1.2.

Prior to combining the polysulfone and crosslinking agent, the polysulfone may be combined with other components, for example other cationic polymers. In certain implementations, the chloromethylated polysulfone is combined with a benzimidazole prior to the crosslinking reaction. In some implementations the polybenzimidazole is poly[4,4-diphenylether-5,5′-bisbenzimidazole] or poly[2,2′-(m-phenylene)-5,5′-bisbenzimidazole]. In certain preferred implementations, the chloromethylated polysulfone and polybenzimidazole are present in a weight ratio (prior to crosslinking) from 5:1 to 1:5, from 2.5:1 to 1:2.5, from 1.5:1 to 1:1.5, from 5:1 to 1:1, from 2.5:1 to 1:1, from 1.5:1 to 1:1, from 1:1 to 1:5, from 1:1 to 1:2.5, or from 1:1 to 1:1.5 (polysulfone:benzimidazole).

The chloromethylated polysulfone (either with or without further polymeric intermediates) may be combined with a crosslinking agent in a solvent. The mixture may be drop-casted on a level surface at elevated temperature. In some implementations the solvent is a polar aprotic solvent such as dimethylacetamide, dimethylformamide, dimethyl sulfoxide, and the like. The mixture may be maintained at elevated temperature to ensure complete crosslinking. In some instances, the mixture is drop-casted and held at a temperature from 100-200° C., from 120-200° C., from 140-200° C., or from 140-180° C. After a suitable period of time, for example from 2-12 hours, from 4-12 hours, or from 4-8 hours, the crosslinked film may be separated from the surface and contacted with a tertiary amine, N-heterocycle or N-heteroaromatic compound to give the high temperature polymer electrolyte membrane tethered cationic groups. In some instances, the crosslinked film is submerged in a solution containing the tertiary amine, N-heterocycle or N-heteroaromatic compound. Suitable solutions for the tertiary amine, N-heterocycle or N-heteroaromatic compound including C₁₋₄ alcohols, for example methanol, ethanol, or isopropanol. In some implementations the tertiary amine, N-heterocycle or N-heteroaromatic compound is triethylamine, DABCO, quinuclidine, pyridine, or N-alkylimidazole. A preferred tertiary amine, N-heterocycle or N-heteroaromatic compound is pyridine.

In certain implementations, the crosslinking compound has the formula:

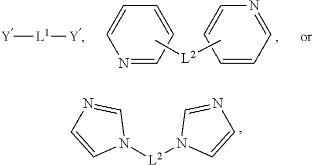

wherein Y′ is OH, SH, NH₂, NH(CH₃), or N(CH₃)₂, and L¹ and L are as defined above.

The crosslinked polysulfone network may then be washed to remove excess tertiary amine, N-heterocycle or N-heteroaromatic compound. The dried crosslinked polysulfone network can have a thickness from 10-250 μm, from 10-200 μm, from 10-150 μm, from 10-100 μm, from 10-25 μm, from 25-100 μm, from 25-50 μm, or from 25-75 μm.

Also disclosed herein are polybenzimidazoles crosslinked with polyvinyl benzyl chloride, wherein the weight ratio of the polybenzimidazole to polyvinyl benzyl chloride (prior to crosslinking) is from 60:40 to 85:15. In some implementations the weight ratio is from 65:35 to 85:15, from 70:30 to 85:15, from 75:25 to 85:15, from 80:20 to 85:15, from 65:35 to 75:25, from 70:30 to 80:20, or from 70:30 to 75:25. In some preferred implementations, the weight ratio is 70:30 to 80:20.

The crosslinked polybenzimidazole network may be prepared by first combining a polybenzimidazole with polyvinyl benzyl chloride in a weight ratio from 60:40 to 85:15. In some implementations the weight ratio is from 65:35 to 85:15, from 70:30 to 85:15, from 75:25 to 85:15, from 80:20 to 85:15, from 65:35 to 75:25, from 70:30 to 80:20, or from 70:30 to 75:25. In some preferred implementations, the weight ratio is 70:30 to 80:20. In some implementations the mixture is drop casted as described above to provide the crosslinked network.

In some implementations the polybenzimidazole is poly[4,4-diphenylether-5,5′-bisbenzimidazole] or poly[2,2′-(m-phenylene)-5,5′-bisbenzimidazole].

After drop-casting and crosslinking the polybenzimidazole with polyvinyl benzyl chloride, the crosslinked product can be reacted with a tertiary amine, N-heterocycle or N-heteroaromatic compound, for instance triethylamine, DABCO, quinuclidine, pyridine, etc, for instance as described above for the crosslinked polysulfone. A preferred reactant is pyridine. The crosslinked network may then be washed and rinsed with solvent to remove excess tertiary amine, N-heterocycle or N-heteroaromatic compound. The dried crosslinked polybenzimidazole network can have a thickness from 10-250 μm, from 10-200 μm, from 10-150 μm, from 10-100 μm, from 10-25 μm, from 25-100 μm, from 25-50 μm, or from 25-75 μm.

### High Temperature Polymer Electrolyte Membranes

The crosslinked polysulfone and crosslinked benzimidazoles may be imbibed with a strong acid to provide a high temperature polymer electrolyte membrane. In certain implementations the strong acid is phosphoric acid, phosphonic acid, sulfuric acid, sulfonic acid, nitric acid, or a combination thereof. In certain implementations the strong acid is phosphoric acid, a phosphonic acid, or a combination thereof. In some implementations the phosphonic acid has the formula R^{a}—PO₃H₂, wherein R^{a} is a C₁₋₃ alkyl. Preferred phosphonic acids include methyl phosphonic acid and ethyl phosphonic acid. Crosslinked networks may be imbibed by contacting the films with the acid at room temperature (~23° C.) or elevated temperature for several hours. In some implementations the elevated temperature is from 50-150° C., from 80-150° C., from 100-150° C., from 100-125° C., or from 110-130° C. In certain implementations, the crosslinked network can be immersed in 85 wt. % H₃PO₄ for 6 hours at 120° C.

### Electrochemical Cells

Also disclosed herein are electrochemical cells containing the ionomer blends and/or high temperature polymer electrolyte membranes disclosed herein. In some implementations, the electrochemical cells include two or more electrodes (i.e., at least one anode and at least one cathode) in electrical communication and a porous separator disposed between the anode and the cathode.

In certain implementations, the porous separator is a high temperature polymer electrolyte membrane as disclosed herein. In certain implementations, the porous separator includes a crosslinked polysulfone network as disclosed herein. In some implementations, the porous separator includes a crosslinked polybenzimidazole network as disclosed herein.

In some implementations, the separator includes a non-crosslinked polymer system. In some implementations, the separator includes a polysulfone of Formula (S):

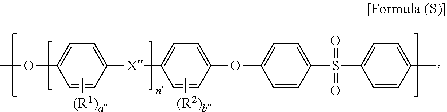

wherein
X″ is selected from null, O, C(═O), C(CH₃)₂, or C(CF₃)₂;
n″ is 0 or 1;
a″ and b″ are in each case independently selected from 0, 1, 2, 3, or 4;
R^{1′} and R^{2′} are in each case methylene substituted by halo, preferably chloro, or a cationic nitrogen group, for example, N(C₁₋₆ alkyl)₃, N-heterocyclyl, or N-heteroaryl, preferably N-pyridinium,
wherein at least one R^{1′} or R^{2′} group comprises a cationic nitrogen group.

In certain implementations, the polysulfone of Formula (S), n is 1 and X is either null or is C(CH₃)₂.

The polysulfone of Formula (S) may be combined with a cationic polymer, for example a polybenzimidazole, and then drop casted and imbibed with a strong acid as described above.

In some implementations the polybenzimidazole is poly[4,4-diphenylether-5,5′-bisbenzimidazole] or poly[2,2′-(m-phenylene)-5,5′-bisbenzimidazole].

In certain preferred implementations, the polysulfone of Formula (S) and polybenzimidazole are present in a weight ratio from 5:1 to 1:5, from 2.5:1 to 1:2.5, from 1.5:1 to 1:1.5, from 5:1 to 1:1, from 2.5:1 to 1:1, from 1.5:1 to 1:1, from 1:1 to 1:5, from 1:1 to 1:2.5, or from 1:1 to 1:1.5 (polysulfone:benzimidazole).

In certain implementations, both the anode and the cathode of the electrochemical cell will include the ionomer blends disclosed herein. In other implementations, only one of the anode or cathode will include the ionomer blend. In some implementations the ionomer blend may be present on the anode, and in other implementations the ionomer blend may be present on the cathode.

In certain implementations, the anode can include the ionomer blend (optionally with ionic liquid) in an amount of from 2-25 wt. %, from 5-25 wt. %, from 5-15 wt. %, from 5-10 wt. %, from 7.5-12.5 wt. %, or from 10-15 wt. %.

In certain implementations, the cathode can include the ionomer blend (optionally with ionic liquid) in an amount of from 2-25 wt. %, from 5-25 wt. %, from 5-15 wt. %, from 5-10 wt. %, from 7.5-12.5 wt. %, or from 10-15 wt. %.

Also disclosed herein are hydrogen pumps including the disclosed ionomer blends and/or high temperature polymer electrolyte membranes. A hydrogen pump includes at least one anode and cathode in electrical communication, and a high temperature polymer electrolyte membrane disposed between them. The ionomer blends disclosed herein may be present on the anode, the cathode, or both the anode and the cathode. A gaseous mixture containing H₂ is received by the anode, wherein the H₂ is split into protons and electrons. The protons travel across the membrane (which is substantially impermeable to larger species) to reach the cathode, where they recombined with electrons to regenerate purified H₂. In certain implementations, the hydrogen pump includes a second cell including a second anode and second cathode in electrical communication, and a second high temperature polymer electrolyte membrane disposed between them. The purified H₂ is directed from the first cathode to the second anode, wherein it is again split into protons and electrons. The protons travel across the second membrane, where they are recombined at the second cathode to yield twice-purified H₂. In certain implementations, the hydrogen pump can include further cells to further purify the hydrogen gas. In certain implementations, the hydrogen pump includes three cells, four cells, or five or more cells.

Also disclosed herein are methods of using such systems to purify hydrogen gas. In certain implementations, a gaseous mixture including H₂ is supplied to the anode of a first electrochemical cell. The anode splits the H₂ into protons and electrons. The protons travel across a high temperature polymer electrolyte membrane to a cathode, where they are recombined. The anode may include an ionomer blend as disclosed herein with electrons to regenerate H₂. The cathode may include an ionomer blend as disclosed herein. In some implementations, the anode and cathode both contain the same ionomer blend.

In certain implementations, the regenerated H₂ is directed to a second anode, wherein it is split into protons and electrons. The second anode may include an ionomer blend as disclosed herein. The protons travel across a second high temperature polymer electrolyte membrane to a cathode, where they are recombined with electrons to regenerate further purified H₂. The second cathode may include an ionomer blend as disclosed herein. In some implementations, the anode and cathode both contain the same ionomer blend. This sequence may be repeated as desired to yield further purified H₂.

### EXAMPLES

The following examples are for the purpose of illustration of the invention only and are not intended to limit the scope of the present invention in any manner whatsoever.

Pentafluorostyrene monomer, triethyl phosphite (TEP), petroleum ether, poly(vinyl phosphonic acid) (PVPA), and hexachloroplatinic acid were purchased from Sigma Aldrich and used as is. Sodium dodecyl sulfate, monosodium phosphate, potassium peroxydisulfate, dimethylacetamide (DMAc), and N-methyl-2-pyrrolidone (NMP) were obtained from Sigma Aldrich. DMAc and NMP were HPLC grade. Poly(vinyl benzyl chloride) (PVBCI) was purchased from Scientific Polymer Products. Trimethyl silyl phosphite was purchased from TCl Chemicals. Nafion™ and Aquivion® dispersions were purchased from Fuel Cell Store and were used as is. Poly(styrene-block-2-vinyl pyridine) (PSbPVP) block copolymers were purchased from Polymer Source Inc. and used as is. Si/SiOx wafers with 1 μm thick thermally grown oxide layer used in IDE manufacture were purchased from WRS Materials. Deionized water (DI) was withdrawn before use and was 18.2 MO. Deuterated solvents such as D6 DMSO and D8 THE were obtained from Sigma Aldrich.

### Example 1A: Synthesis of poly(pentafluorostyrene-co-tetrafluorostyrene-phosphonic Acid) (“PTFSPA”)

Pentafluorostyrene was polymerized using emulsion polymerization in a reaction mixture containing 100 mg (0.346 mmol) of sodium dodecyl sulfate and 10 mg (0.042 mmol) of monosodium phosphate dissolved in 10 g of deionized and degassed water in a 100 mL round bottom flask. 23 mg (0.95 mmol) of potassium peroxydisulfate was added to the mixture, stirred, and heated until dissolved. The round bottom flask containing the said components was then immersed in an oil bath heated to 100° C. The headspace of the reaction vessel was blanketed with nitrogen and the flask was sealed. 5 g (25.8 mmol) of pentafluorostyrene was added to the reaction mixture with vigorous stirring from an overhead stirrer. The polymerization reaction occurred over 5 hours with constant stirring. Afterwards, the solution was cooled to room temperature and the solution was poured into isopropanol (100 mL) to precipitate the poly(pentafluorostyrene) polymer. The solid polymer was filtered and dried in a vacuum chamber. The polymer appearance was a white powder, and the yield was 4.6 g (i.e., 92% conversion of the monomer to polymer).

1 g (5.2 mmoles) of the synthesized poly(pentafluorostyrene) was dissolved in 4 g of dimethylacetamide (DMAc) at 170° C. The reaction vessel was sealed and blanketed with nitrogen. 1.07 g (3.6 mmol) of tris-trimethylsilyl phosphite was added to the reaction vessel and the phosphonation reaction proceeded for 16 hours. After that, the PTFSPA solution was cooled and the PTFSPA was precipitated by pouring the polymer solution into 250 mL of boiling DI water. The precipitated polymer was stirred in boiling DI water to hydrolyze the tethered phosphite to phosphonic acid. Then, the precipitated polymer was filtered, and it was rinsed in boiling water thrice for half an hour each time. Further, the polymer was boiled in 2 wt. % phosphoric acid to convert the phosphonate ester into phosphonic acid form. After that, the polymer was filtered and washed with copious amounts of DI water until a filtrate pH of 6 to 7 was attained. The polymer was dried under a vacuum to obtain PTFSPA. The ³¹P NMR spectrum in confirmed the presence of phosphonic acid in PTFSPA. Furthermore, the IEC of the synthesized PTFSPA was determined using acid-base titration and is reported in the Table below.

### Example 1B: Synthesis of Poly(Vinyl Benzyl Phosphonic Acid) (“PVBPA”)

1 g of poly(vinylbenzyl chloride) was dissolved in 22.5 ml of triethyl phosphite (TEP). The reaction vessel was sealed and heated to 120° C. After 24 hours, the phosphonated polymer was precipitated in petroleum ether, filtered, and dried under vacuum at 80° C. to recover poly(vinyl benzyl phosphonate ester). The polymer was hydrolyzed to generate benzyl phosphonic acid tethered to the polymer backbone. The hydrolysis reaction was conducted by dispersing the poly(vinyl benzyl phosphonate ester) in concentrated hydrochloric acid (10 mL, 37%) and stirring it for 24 hours at 90° C. After 24 hours, the polymer dispersion was cooled and gradually poured into an excess volume of DI water. The precipitated polymer was filtered and washed several times until the filtrate was pH 6 to 7. The collected PVBPA was dried under a vacuum at 60° C. The ³¹P NMR spectrum confirmed the presence of phosphonic acid in PVBPA. The Table below reports the IEC of the synthesized PVBPA.

| | | | | | Maximum thin | |
|---|---|---|---|---|---|---|
| | | | Anhydride | | film proton conductivity | |
| | | | formation (%)^{b} | | (mS · cm⁻¹)^{c} | |
| | IEC | P/S | No | With | No | With |
| Material | (mmol · g⁻¹)^{a} | ratios | Aquivion ® | Aquivion ® | Aquivion ® | Aquivion ® |
| PTFSPA | 1.56 | 0.5, 1.0, 1.6, | 21.2 | 0 | 18.2 | 42.5 |
| | | 2.0, 4.7 | | | | |
| PVPA | 6.80 | 1.0, 2.0, | 100 | 48 | 1.2 | 8.9 |
| | | 4.0, 5.3 | | | | |
| PVBPA | 5.23 | 2.7 | 58.3 | 0 | 12.3 | 34.5 |

^{a}Measured using acid-base titration or calculated from equivalent weight;
^{b}Evaluated by solid-state ³¹P NMR;
^{c}Evaluated using interdigitated electrode arrays (IDAs).
Note:
The IEC of Aquivion ® was 1.02 mmol · g⁻¹ and the IEC of Nafion ™ was 0.91 mmol · g⁻¹. These values are based on their equivalent weight values.

### Example 2: Interdigitated Electrode Array (IDA)

To fabricate IDAs, a lift-off resist (LOR™ SA) was spin-coated onto a silicon wafer (with a thermally grown oxide layer of 1 μm) at 4000 rpm for 45 s and subsequently baked at 185° C. for 3 mins. After this, a positive photoresist (SPR™ 3012) was spin-coated on top of the lift-off resist at 4000 rpm for 45 s and subsequently baked at 80° C. An MA/BA Gen4-serie mask and bond aligner tool were used to expose the photoresist (60 mJ/cm²) to generate the IDA pattern. The exposed parts of the photoresist with the IDA patterns were developed by immersing the wafer with the exposed resist in a Microdeposit® MF® CD-26 developer base for 1 minute, followed by a thorough rinse with DI water. Then, 15 nm of titanium (Ti) was e-beam evaporated on the substrate followed by e-beam evaporation of 135 nm of gold (Au). The e-beam evaporator used was Temescal FC-2000. Lift-off of the photoresist was performed with NMP at 70° C. followed by excess rinsing with DI water and drying with nitrogen. The 4-inch wafer had 105 individual IDAs.

The IDAs fabricated were washed to remove impurities from fabrication. First, the IDAs are sonicated in acetone (using an ultrasonic bath) for 10 minutes and then sonicated in NMP for 5 minutes. Then, the IDAs were washed using IPA/water mixture and air-dried.

IDAs decorated with a thin film of nanoscale electrocatalyst were prepared by spin coating a mono-hydroxy terminated random copolymer of poly(styrene-co-2-vinyl pyridine) onto the IDA substrate followed by grafting the brush to the substrate at 200° C. for 10 minutes under an inert (nitrogen) atmosphere. The non-grafted polymer (i.e., excess material) was rinsed off the substrate by immersing it in toluene and placing it in an ultrasonication bath for 10 minutes. The random copolymer brush was grafted to the IDA substrate to create a non-preferential surface for the block copolymer template to be added in the next step. A block copolymer of poly(styrene-block-2-vinyl pyridine) (PSbP2VP) was dissolved in toluene at 1.5 wt. % and was spin-coated on the IDA substrate with a non-preferential random copolymer brush followed by solvent annealing with acetone vapor (45 sccm nitrogen saturated with acetone and 5 sccm dry nitrogen at room temperature for about 2 hours) to form microphase separated perpendicular lamellae block copolymer. The block copolymer film was about 35 nm and then the block copolymer film on the IDA was exposed to iodomethane to perform a Menshutkin reaction that alkylates the pyridine moiety to n-methyl pyridinium iodide in PSbP2VP. The alkylated pyridine groups favor greater chloroplatinate uptake that ultimately results in thicker platinum nanowires. After the Menshutkin reaction step with iodomethane, the IDAs with the alkylated, self-assembled block copolymer film, the P2VP block was loaded with chloroplatinate ions by immersing in 10 mM hexachloroplatinic acid solution. Then, the IDA substrate with chloroplatinate was etched with oxygen (to remove the polymer) and then with argon to convert the nanostructures to metal form. The etching step is done using Reactive ion etcher (RIE) Plasma-Therm 720. The nano catalyst-decorated IDAs are used as such for the HOR/HER experiments.

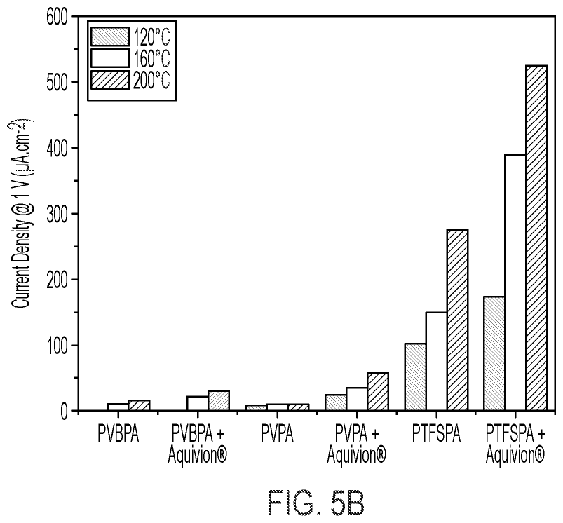

All the IDA experiments were conducted in a flow chamber with two electrical connections to measure the electrochemical properties of the ionomer materials. The flow chamber passes either nitrogen (for conductivity experiments) or hydrogen (for EHP experiments). The IDA is equilibrated for 30 minutes under the passing gas before each experiment commences. All measurements were made using Gamry Potentiostat (3000AE). Galvanostatic EIS is performed for determining the in-plane film resistance. EIS experiments were performed with frequencies from 100,000 Hz and 1 Hz and with AC amplitude of 0.01 mA, by passing nitrogen for conductivity measurements. Chronoamperometry (from 0 to 1 V with an increment of 0.1 V) and EIS experiments (100,000 Hz and 1 Hz and with AC amplitude of 0.1 mA) were performed for the IDA hydrogen pump while passing hydrogen gas. The current density in the polarization curves shown in FIG. 5A was calculated by dividing the current obtained by the active area of the electrochemical cell in IDA (which is 0.0495 cm⁻²).

The molecular weight of the polymer PPFS was analyzed by gel permeation chromatography (GPC) Tosoh HLC-8320 model with a built-in RI detector, with a flow rate of 0.35 mL/min. The column used is a Waters Styragel HR 5e. Additionally, our system is fitted with a Wyatt MALS detector. The concentrations used in our instrument range from 1 mg/mL to 5 mg/mL.

We first examined the ionomer blend compatibility when mixing the phosphonic acid ionomers with PFSA materials. SEM-EDS map images identified phosphorus (on film's surface). We observed uniform phosphorus distribution across the image. SEM-EDS for PVPA-Aquivion® and PVBPA-Aquivion® blends images convey uniform distribution of the fluorine. SEM-EDS images were collected at three different places on the sample, and each image was similar. The AFM images demonstrated that Aquivion® was not phase separated in the thin films of blended ionomers.

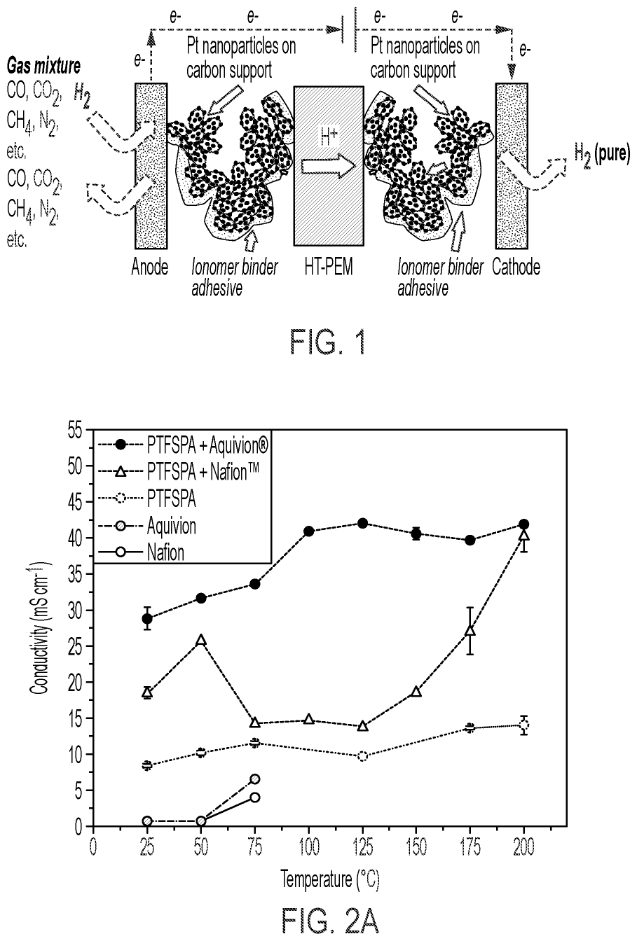

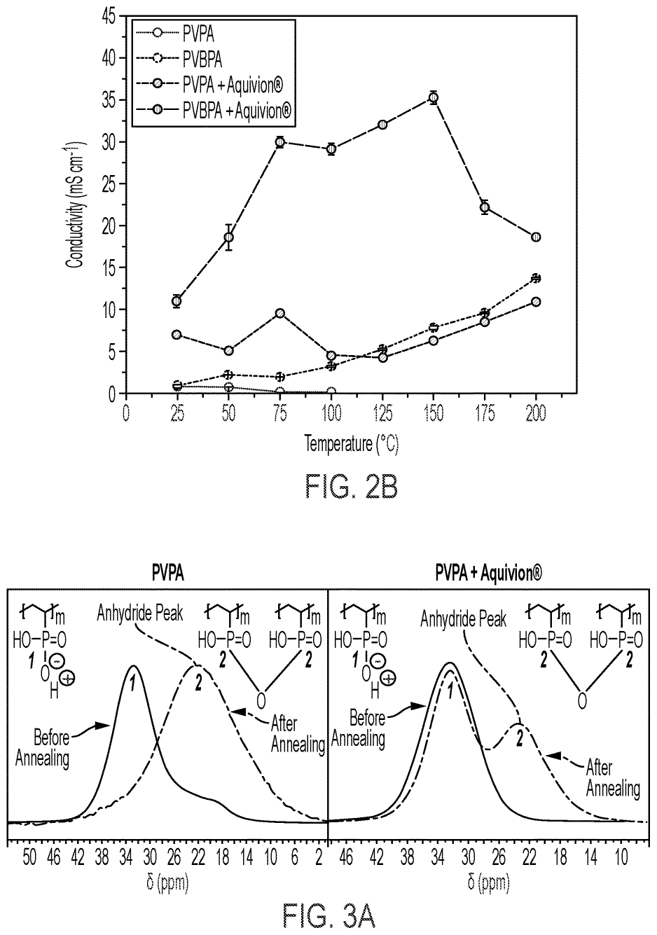

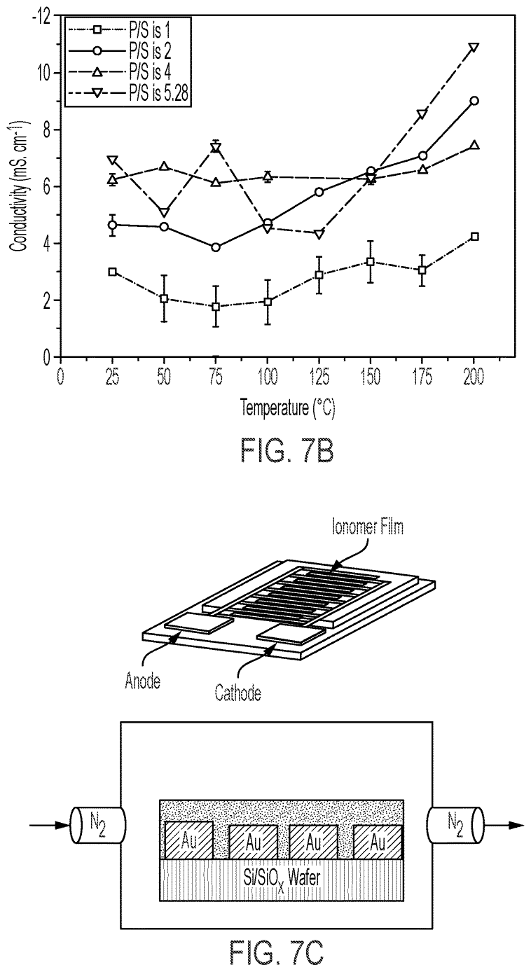

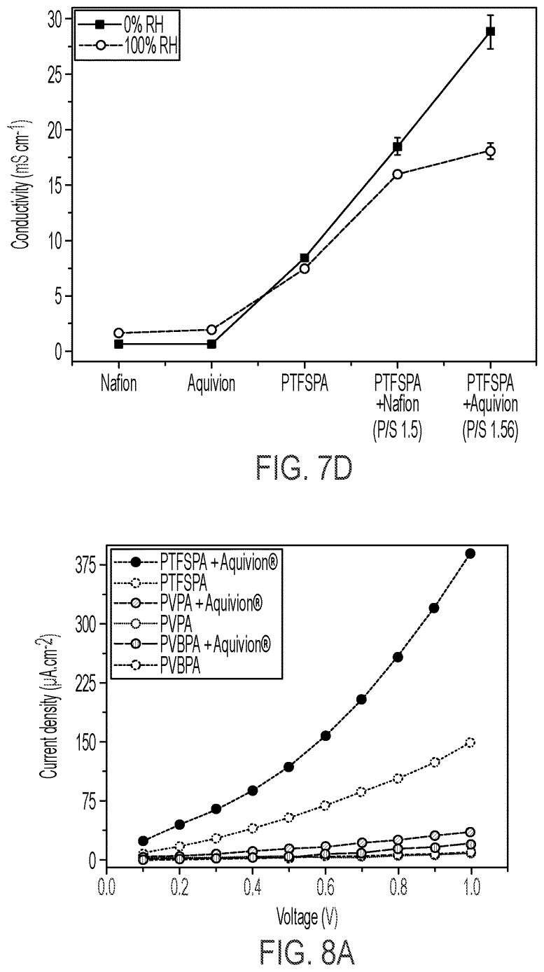

The ionic conductivity was studied as a thin film because the ionomer binder in the porous electrodes is often a thin film (<100 nm and closer to ~10 nm)³⁴ on the electrocatalyst-electrocatalyst particle support. Studying the ionomer materials as thin films alleviates the need to prepare mechanically robust, free-standing membranes of the PFSA-phosphonic acid ionomer blends. The proton conductivity experiments were performed under controlled temperature and dry nitrogen (i.e., 0% RH) as shown in FIG. 7C. FIG. 2 compares the thin film ionic conductivity of PTFSPA, PVPA, PVBPA, Nafion™, and Aquivion® ionomers and PTFSPA-Nafion™ and PTFSPA-Aquivion® blends. The Nafion™ and Aquivion® ionic conductivity is very low at 0% RH and its negligible at temperatures higher than 100° C. because the higher temperature and dry environment removed residual water from the PFSA materials—which is needed to mediate proton conductivity. PTFSPA has the highest ionic conductivity of the non-blended samples. adding Nafion™ and Aquivion® to PTFSPA improved the ionic conductivity by about 150% and 250%, respectively at 150° C. PTFSPA-Aquivion® gave the highest ionic conductivity of all the samples tested and was better than PTFSPA-Nafion™. Aquivion® has a shorter side chain compared to Nafion™ and a higher IEC value. Both attributes improve proton conductivity under drier conditions.

FIG. 2b compares the proton conductivity of PVPA and PVBPA with and without Aquivion® added. Not only did the addition of Aquivion® enhance PTFSPA proton conductivity, but it also increased the proton conductivity of PVPA and PVBPA. These materials, PVPA and PVBPA, by themselves, had very low proton conductivity. PVPA has very low ionic conductivity due to its propensity to form non-ionic, phosphate ester groups (i.e., anhydrides). PVPA is commercially available, and so is Aquivion®; hence, researchers can use these commercial materials for HT-PEM electrochemical systems. PVBPA is derived from poly(vinyl benzyl chloride), which is much lower in cost and produced in much larger volumes when compared to poly(pentafluorostyrene).

FIGS. 7a and 7b show the proton conductivity data for different phosphonic acid and PFSA blends with different phosphonic acid to sulfonic acid (P/S) ratios. In the case of PTFSPA with Aquivion®, a P/S ratio of 1 to 2 gave the highest proton conductivity and for PVPA with Aquivion®, a P/S ratio of 2 to 5.28 gave higher proton conductivity values. However, a P/S ratio of 1 showed low proton conductivity.

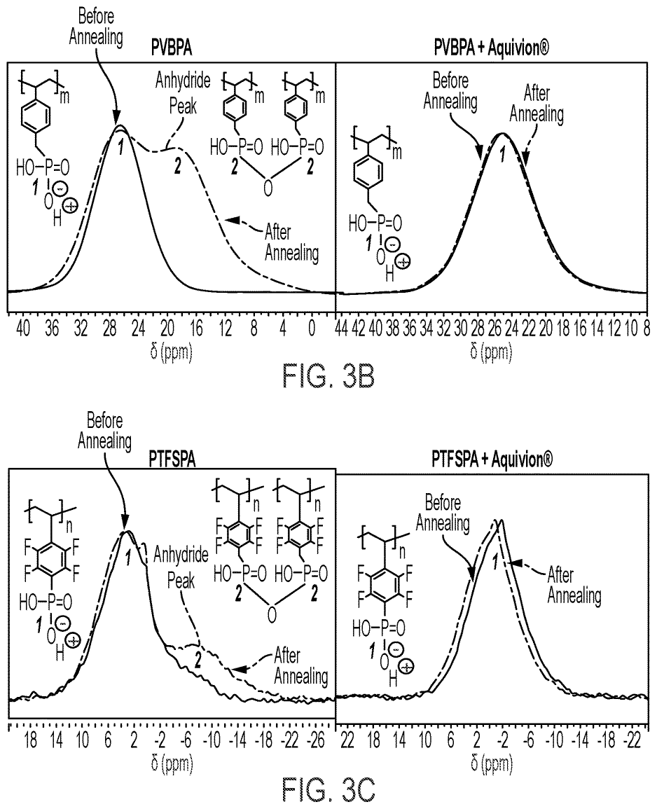

Solid-state ³¹P NMR was performed to measure the reduction in phosphate ester formation (i.e., anhydride formation) upon PFSA addition to the various phosphonic acid ionomers. Solid-state NMR was used as the characterization technique because it can discern phosphonic acid from phosphate ester and it allowed the blended samples to be processed as solids under the aggressive thermal annealing treatment of 250° C. for 5 hours under nitrogen to spur anhydride formation. Furthermore, it avoided solubility challenges that would inevitably arise from inter-chain crosslinking upon anhydride formation. FIGS. 3A-C correspond to the phosphonic acid ionomers before (red trace) and after thermal annealing (green trace). For the PVPA material only shown in FIG. 3A, the downward shift in the peak by 12 ppm found in ³¹P NMR spectra signaled that all the phosphonic acid groups converted to phosphate ester upon thermal annealing. In the case of PVBPA and PVPA (FIGS. 3B and 3C), thermal annealing caused a large conversion of phosphonic acid to phosphate ester (58.3% and 100%, respectively). PTFSPA, on the other hand, showed a 21.2% conversion of phosphonic acid to phosphate ester. Adding Aquivion® to the 3 different phosphonic acid ionomers (FIGS. 3A-3C) mitigated anhydride formation completely upon the same thermal annealing treatment and drastically reduced anhydride formation by 48% in PVPA. Table 1 lists the % of anhydride in the samples after thermal annealing of the phosphonic acid ionomers and phosphonic acid ionomers blended with Aquivion®.

The reduction in phosphate ester formation upon adding Aquivion® was attributed to the superacid nature of the PFSA material. Acids and bases can hydrolyze anhydrides to tethered anions that are dissociated. Furthermore, the proton in the sulfonic acid moiety of the PFSA can enhance the proton activity of the phosphonic acid group, which has been described as the protonation of the phosphonate by the sulfonic acid. Mitigating phosphate ester formation and protonating phosphonate groups in phosphonic acid ionomers with the addition of Aquivion® accounts for the improved proton conductivity of phosphonic acid ionomers with Aquivion®.

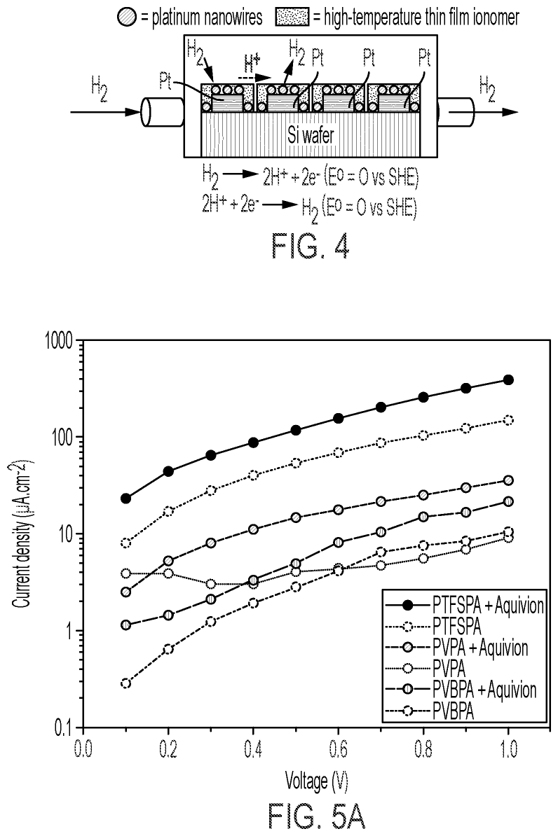

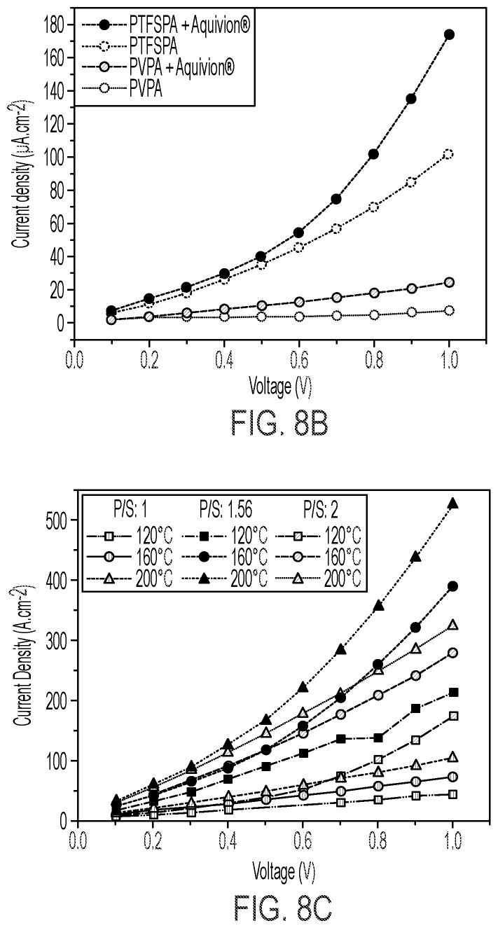

The next experiments utilized IDAs decorated with nanoscale electrocatalysts prepared from block copolymer templates to determine how the ionomer and ionomer blend materials affect EHP polarization. These IDA chips (FIG. 4) allowed us to perform EHP experiments with thin films of PTFSPA and a polycation imbibed with phosphoric acid. The IDAs use 100× less platinum group metal loadings when compared to a standard 5 cm² MEA and do not require a bulk membrane separator. FIG. 5A shows the IDA EHP polarization curves for PVPA, PVBPA, and PTFSPA, and the same phosphonic acid ionomers blended with Aquivion® at 200° C. and 0% RH. FIGS. 8A and 8B give the polarization curves for the same materials at 120° C. and 160° C. The P/S ratio of the phosphonic acid ionomer blended with PFSA which gave the highest proton conductivity was used for the EHP IDA studies. FIG. 5A and FIGS. 8A-B demonstrate that the addition of Aquivion® to each of the phosphonic acid ionomer chemistry reduced EHP polarization.

The reduction in polarization with the addition of Aquivion® arises from improved HOR/HER kinetics and potentially improved hydrogen permeability. FIG. 5B compares the IDA current density at a cell voltage of 1 V for the various ionomer and ionomer blend thin films. PTFSPA-Aquivion® provided the highest current density at 1 V and PTFSPA provided the second highest current density when used as a thin film electrolyte on the IDA. The current density at 1 V for the various temperatures was very low with PVPA and PVBPA ionomers as thin films. Adding Aquivion® to these two phosphonic acid ionomers improved the current density, but PVPA and PVBPA with Aquivion® showed lower current density values at 1 V when compared to the IDA with a PTFSPA thin film ionomer. The large loading of phosphonic acid groups in PVPA and PVBPA compared to PTFSPA accounts for the lower HOR/HER kinetics when using PVPA and PVBPA. Adding Aquivion® reduces the number of phosphonic acid groups available in the phosphonic acid ionomers to adsorb to the nanoscale electrocatalysts. Plus, the fluorine moieties in the pentafluorostyrene ring of PTFSPA increase the acidity resulting in improved HOR/HER kinetics. We also studied the PTFSPA-Aquivion® blended ionomer at various P/S ratios on IDA decorated with Pt nanocatalyst. The results are reported in FIG. 8C. We were able to see the same trends in the polarization data as obtained in the thin film proton conductivity measurements. Overall, the IDAs with and without nanostructured electrocatalysts allowed us to determine which thin film ionomer and ionomer blends gave the best ionic conductivity and the lowest EHP polarization—which encompasses HOR/HER kinetics and hydrogen gas transport.

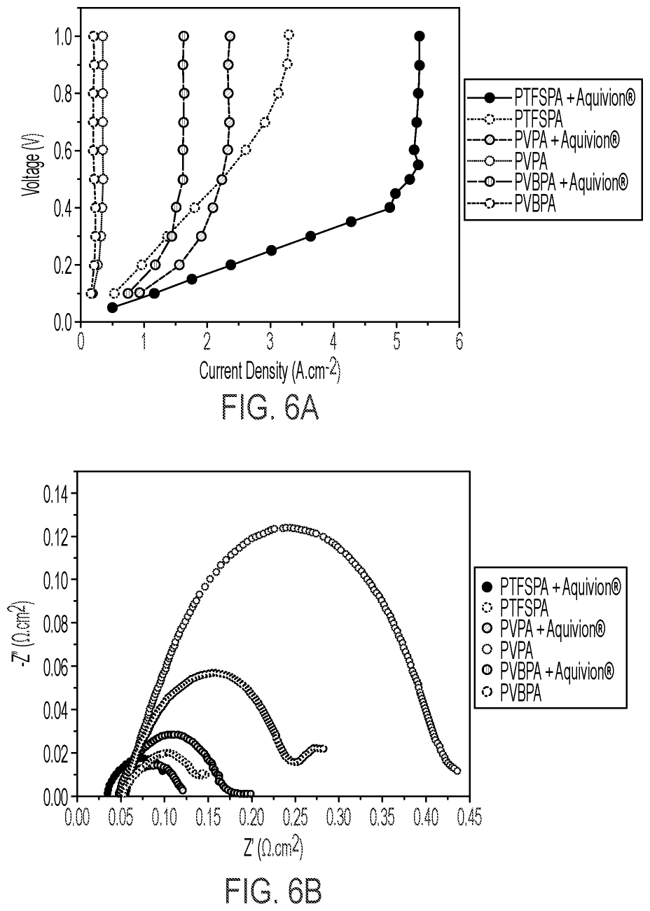

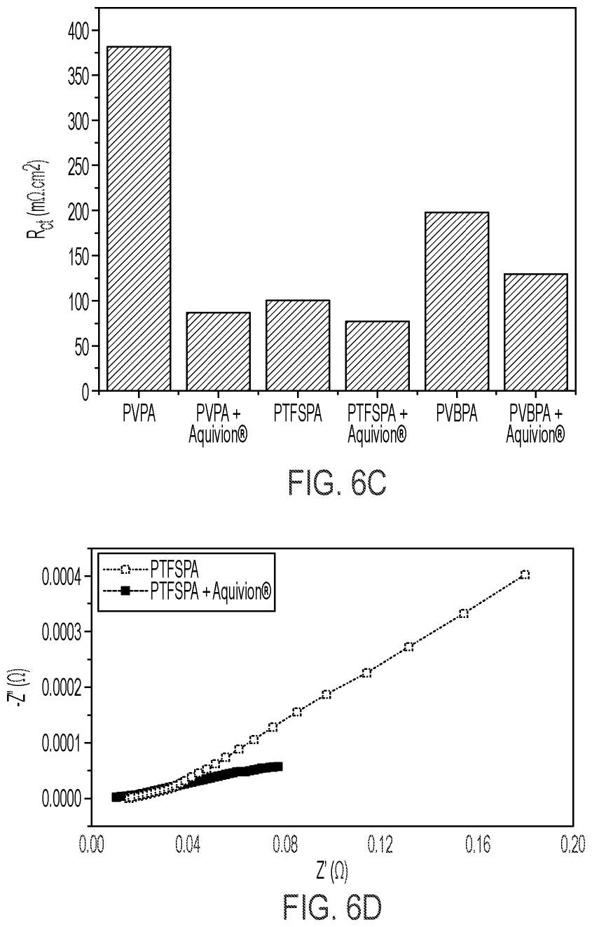

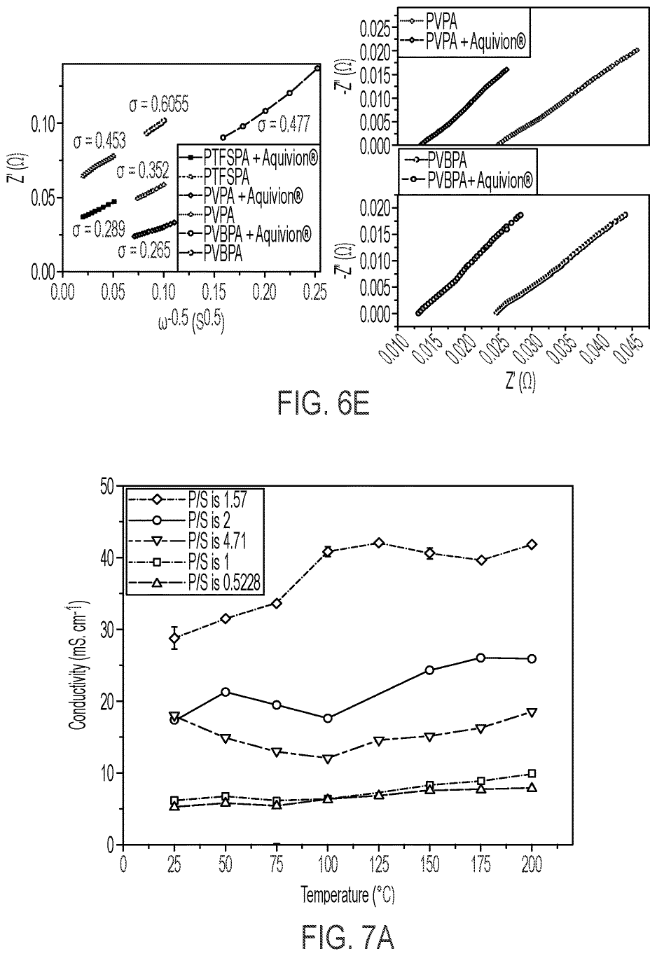

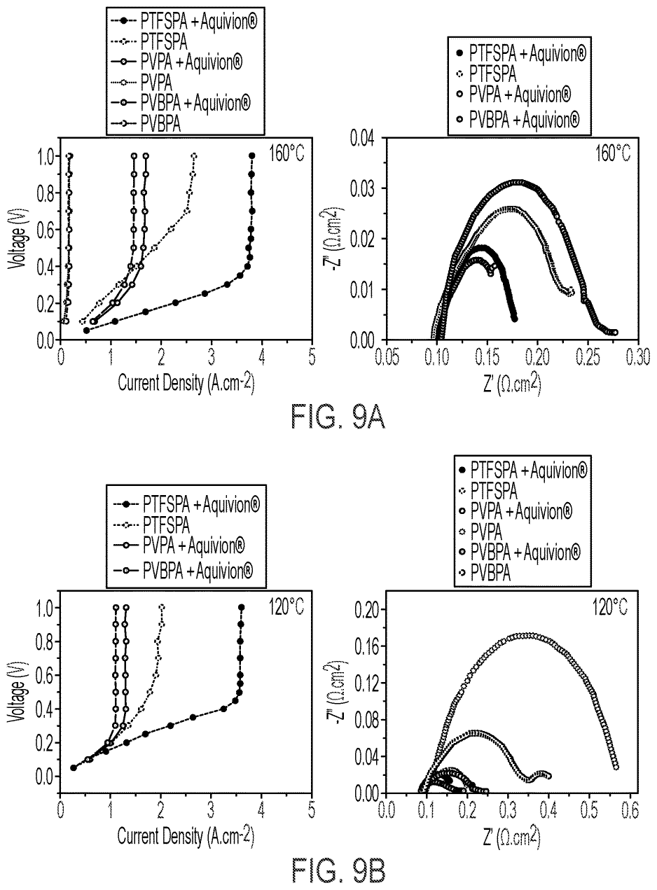

The final experiments assessed various ionomer and ionomer blend materials as electrode binders in a single-cell EHP. The MEAs with various ionomer binders used the same ion-pair HT-PEM and gas diffusion electrodes (GDEs)—which consisted of 10 wt % of ionomer binder material with 1.0 mg_{Pt} cm⁻². The cell temperatures and anode feed gas flow rate with pure hydrogen (0.2 slpm) are the same for each MEA tested. In other words, these experiments examine how the electrode ionomer binder influences EHP polarization. FIG. 6A gives the polarization curves of the EHP at 200° C. for the MEAs with different electrode ionomer binder materials. FIG. 9 provides the polarization curves for the MEAs at 160° C. and 120° C. The said effects result in less polarization. Conversely, we examine the system at lower temperatures because lower temperature operation endows better durability of the cell. FIG. 6A demonstrates addition of Aquivion® reduced the polarization of the EHP, and this was especially significant when using PVPA and PVBPA binders because these binders by themselves manifested a limiting current with a small amount of cell voltage. The PVPA-Aquivion® had lower polarization when compared to PVBPA-Aquivion® despite PVBPA-Aquivion® having higher ionic conductivity as seen in FIG. 2B. An EHP polarization curve of 5.1 A·cm² at 0.4 V was attained with PTFSPA-Aquivion® binder—which is the highest value in the peer-reviewed literature A reasonable EHP polarization curve, such as 2.25 A·cm² at 0.5 V, could be attained with PVPA-Aquivion®.

| | | | | | |
|---|---|---|---|---|---|
| | | Anode/Cathode | | Maximum current | |
| | | PGM loading | T | density for given | |
| Electrode/binder type | Membrane Used | mg_{Pt}cm⁻² | (°C) | voltage (A · cm⁻²/V) | Ref |

Prior examples

| | | | | | |
|---|---|---|---|---|---|
| PTFSPA | PA doped QPPsf and PBI | 0.5/0.5^{a} | 200 | 1.5/0.40 | 1 |
| BASF (Pt) | Para-PBI | 1.0/1.0 | 200 | 1.0/0.13^{b} | 2 |
| BASF (Pt) | PBI | 1.0/1.0 | 180 | 2/0.21^{b} | 3 |
| Etek (Pt) | PBI | 1.0/1.0 | 160 | 2.2/0.75 | 4 |
| PBI (Pt/C) | Fumatech PBI | — | 160/0 | 2/0.35^{b} | 5 |

Embodiments according to the disclosures

| | | | | |
|---|---|---|---|---|
| PVPA and Aquivion ® | PA doped QPPsf and PBI | 1.0/1.0 | 200 | 2.3/0.60 |
| PTFSPA and Aquivion ® | PA doped QPPsf and PBI | 1.0/1.0 | 200 | 5.1/0.40 |

^{a}For higher loadings the limiting current density values are not reported;
^{b}current densities for higher voltages are not disclosed.
1 - Materials Advances, 2021, 2, 4228-4234;
2 - ACS Sustainable Chemistry & Engineering, 2020, 8, 6234-6242;
3 - Journal of Natural Gas Science and Engineering, 2010, 2, 229-234;
4 - B. C. E. Benicewicz, Glenn A.; Kumar, S. K.; Greenbaum, S. G, Journal, 2014;
5 - Journal of Power Sources, 2008, 177, 478-484.

EIS was performed on the MEAs in an operating EHP to assess ohmic, charge-transfer, and diffusion resistances in the MEAs with the different binder materials. Prior to discussing charge-transfer resistances, it is important to note that the high-frequency resistance (HFR) for all the MEAs at 200° C. was 0.045 to 0.050 Ω-cm²—FIG. 6B which is a fairly low value. and FIG. 9 provide the Nyquist plots with a background (DC bias) voltage of 0.05 V during EHP operation for the MEAs with different electrode binders. Using this background voltage resulted in a kinetically controlled EHP, and this is evident by the single semi-circle plots in the Nyquist plots with no diffusion tail. Using the diameter values of the semi-circles in FIG. 6B and subtracting the high-frequency resistance values, the charge-transfer resistance values for HOR/HER with the different electrode binders in the MEAs were determined and plotted in FIG. 6C. This plot conveys that adding Aquivion® to each of the phosphoric acid ionomers reduced R_{ct} and the reductions in R_{ct} were significantly greater for the PVPA and PVBPA systems when adding Aquivion®. At small background voltage biases, the R_{ct} is inversely commensurate to the exchange current density (iₒ)—which is a proxy for the reaction rate coefficient for HOR/HER³⁵. Hence, the addition of Aquivion® is shown to promote electrode kinetics.

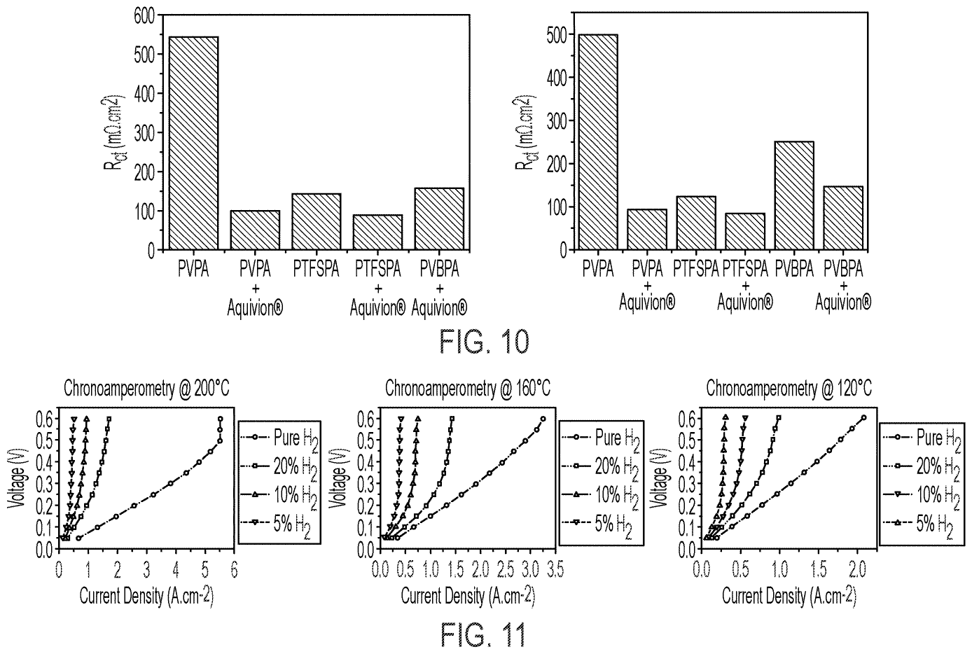

FIG. 6D is the Nyquist plot for the different MEAs with a background voltage of 0.75 V during EHP operation to assess the diffusion resistance for mass-transfer controlled EHP. The limiting current occurs for all the MEAs at 0.75 V. The traces in FIG. 6D show oblique lines in the low-frequency regime indicating a diffusion-controlled process. FIG. 6E is the Warburg plot constructed from the low-frequency EIS data in FIG. 6C. The calculated diffusion resistance (σ) from the slope of the lines is given in FIG. 6E. The incorporation of Aquivion® with each of the phosphonic acid ionomers reduced a by improving hydrogen gas diffusivity as σ scales to D_{H2}^{-0.5}. The corresponding Nyquist plots and calculated HFR values and R_{ct}, for the various MEAs tested in the EHP at 160° C. and 120° C. are given in FIGS. 9 and 10. The trends seen at 200° C. were qualitatively the same at 120° C. and 160° C. Overall, MEA polarization curves and Nyquist plots demonstrate that the addition of Aquivion® promotes electrode kinetics for HOR/HER and hydrogen gas transport.

The reduction in cell polarization when incorporating Aquivion® with the phosphonic acid ionomer electrode binder was primarily attributed to a reduction in activation overpotential and concentration overpotentials. The ohmic overpotential was also reduced, but not significantly as the membrane ohmic resistance dominates the ohmic overpotential in the MEA and the membrane was the same for each MEA.

HT-PEM electrochemical systems have been around for about 30 years. Commercial variants of the MEAs for these systems have in the past primarily used PTFE as electrode binders followed by imbibing the porous electrode with phosphoric acid. Phosphonic acid ionomers blended with perfluorosulfonic acid ionomers are a new class of HT-PEM electrode binders. We show for the first time that adding a PFSA material, like Aquivion®, promotes reaction kinetics and gas transport in HT-PEM EHPs in addition to proton conductivity at 0% RH. Solid state ³¹P NMR showed that the addition of Aquivion® to a variety of phosphonic acid ionomer materials eliminated or significantly reduced phosphate ester formation (i.e., anhydrides) explaining why the Aquivion® addition improves proton conductivity under 0% RH. Electrode ionomer blends of PTFSPA with Aquivion® yielded an HT-PEM EHP that gives 5.1 A cm⁻² at 0.4 V—the highest value in the literature. Furthermore, reasonable EHP performance (i.e., 1.5 to 2 A cm⁻²) was attained with PVPA with Aquivion® and PVBPA with Aquivion® electrode ionomer blends. Using PVPA and PVBPA without Aquivion® as an electrode binder in a HT-PEM EHP resulted in no performance.

### Example 3: Electrochemical Hydrogen Pump

Electrochemical hydrogen pump (EHP) for separating hydrogen (H₂) from the natural gas mixture was carried out in Scribner 850 g test stand. The membrane used in the experiments was a phosphoric acid-doped ion-pair-based (PBI:QPPSf) membrane. The membrane was prepared by drop casting a blended polymer solution (in 50:50 ratio) of 5 wt % polybenzimidazole (PBI) and 5 wt % chloromethylated polysulfone (CMPSf) in N,N-dimethylacetamide (DMAc) on a glass plate, located on a leveling table in an oven. After pouring the solution, the oven temperature was raised to 120° C., and the DMAc solvent was evaporated from the drop-casted solution over 12 hours. The resulting drop casted membrane was peeled off from the glass plate and immersed in a 1 M pyridine solution (in 90% ethanol) at 40° C. for 16 hours. This step converted the chloromethylated group to tethered benzyl pyridinium groups to polysulfone. Afterwards, the membrane is washed with DI water and placed in 85 wt % ortho-phosphoric acid at 120° C. for 6 hours.

The electrode used in the experiment contains 10 wt. % ionomer binder and 90 wt. % Pt/C catalyst. The catalyst loading on the electrodes is 1 mg_{Pt}·cm⁻² on each side. The binder used for the experiment is a blended ionomer of PTFSPA+Aquivion® (with the ratio of phosphonic acid to sulphonic acid being 1.56). The electrodes are prepared by painting the catalyst ink on the gas diffusion layer (GDL) such that the loading of the catalyst is 1 mg_{Pt}·cm⁻². The catalyst ink was prepared by adding 180 mg of Pt/C Tanaka (37.3%) catalyst in a glass vial. Further, the catalyst is wetted with water to avoid any fire hazards. The ionomer solution blend (5 wt % PTFSPA and Aquivion®, in a solvent mixture of THF (used to dissolve PTFSPA) and 2-propanol (dispersing solvent for Aquivion®) added to the glass vial were 400 mg in total. The IEC of PTFSPA was 1.8 mmole·gm⁻¹ and the IEC of Aquivion was 1.02 mmole·gm⁻¹. Hence, to have the phosphonic acid to sulphonic acid ratio of 1.56, 188 mg of 5 wt % PTFSPA solution and 212 mg of 5 wt % Aquivion® dispersion, were added to the vial. Further, the vial is diluted with 3.5 g of THF to get a viscous ink solution. The ink solution is painted on the GDL to obtain the electrodes.

All the experiments were conducted with a cell area of 4.3 cm². Gamry reference 3000 and Reference 30k Booster were used for the electrochemical measurements. Chronoamperometry (from 0 to 0.6 V with an increment of 0.05 V) was performed for the EHP testing. The gas outlet from the cathode was analyzed using Agilent micro-GC.

EHP H₂ separation from natural gas experiments was performed at three different temperatures (120° C., 160° C., and 200° C.) and three different hydrogen concentrations (5 mole %, 10 mole %, and 20 mole %) in the natural gas mixture. The natural gas mixture composition (excluding hydrogen) is shown below. For the backpressure experiment, a back pressure of 150 kPa was applied on the cathode, and a varying back pressure of 0 and 75 kPa was applied on the anode. For the durability experiment, the cell voltage required for a constant current density of 1 A·cm⁻² was recorded for 100 hours at 200° C. and 10% H₂ concentrations at the anode and without any back pressure.

Natural gas composition (mol %)

| | |
|---|---|
| Methane | 95.874 |
| Ethane | 1.4 |
| Propane | 0.4 |
| Isobutane | 0.05 |
| Butane | 0.025 |
| Hexane | 0.017 |
| Heptane | 0.017 |
| Octane | 0.016 |
| CO₂ | 1.9 |
| N₂ | 0.301 |

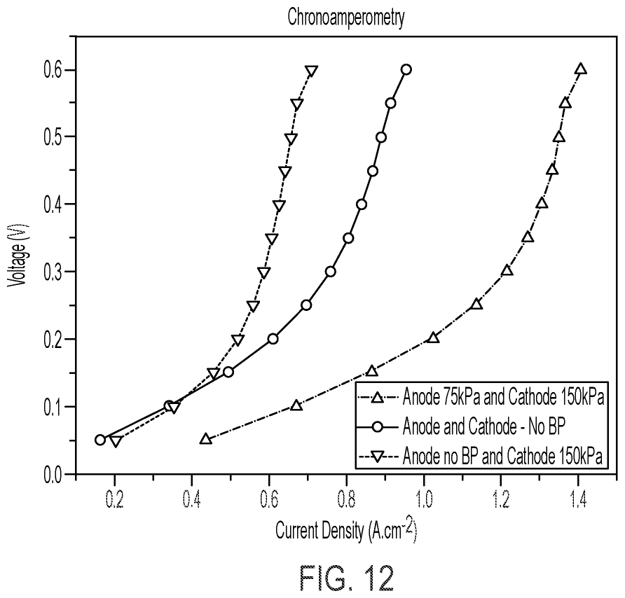

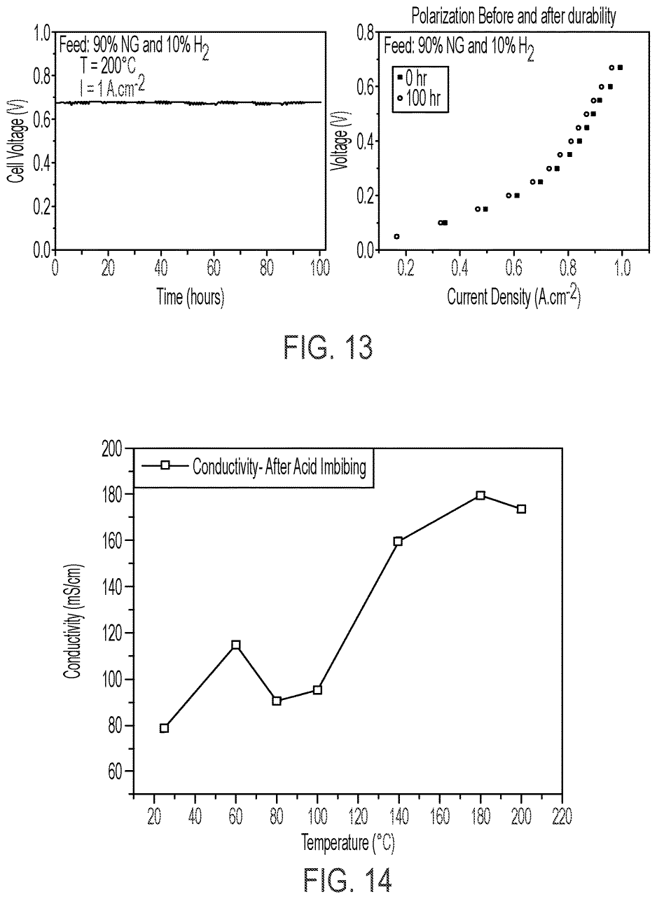

Polarization curves for the various gas mixtures are depicted in FIG. 11. FIG. 12 depicts a polarization curve with backpressure. FIG. 13 depicts the durability of the test cells over 100 hours.

Micro-GC Analysis at 200 °C and 5% H₂ in Anode

| | |
|---|---|
| @ 0.25 A · cm⁻² | @ near limiting current (0.48 A · cm⁻²) |

| | | | |
|---|---|---|---|
| H₂ | 0.993718623 | H2 | 0.993562492 |
| CH₄ | 0.005781722 | CH₄ | 0.005392931 |
| N₂ | 0.000190345 | N₂ | 0.000206486 |
| CO₂ | 0.00030931 | CO₂ | 0.000230779 |
| | | CH₃CH₃ | 0.000607312 |

Micro-GC Analysis at 160 °C and 5% H₂ in Anode

| @ 0.1 A · cm⁻² | | @ near limiting current (0.4 A · cm⁻²) | |
|---|---|---|---|
| H₂ | 0.997425035 | H2 | 0.996691944 |
| CH₄ | 0.001126473 | CH₄ | 0.001793984 |
| N₂ | 0.001113304 | N₂ | 0.001183266 |
| CO₂ | 0.000227449 | CO₂ | 0.000241743 |
| CH₃CH₃ | 0.000107739 | CH₃CH₃ | 0.0000890631 |

Micro-GC Analysis at 120 °C and 5% H₂ in Anode

| @ 0.1 A · cm⁻² | | @ near limiting current (0.3 A · cm⁻²) | |
|---|---|---|---|
| H₂ | 0.990968821 | H2 | 0.990391423 |
| CH₄ | 0.008720583 | CH₄ | 0.008104076 |
| N₂ | 0.000083622 | N₂ | 0.001175786 |
| CO₂ | 0.000167244 | CO₂ | 0.000240214 |
| CH₃CH₃ | 0.000167244 | CH₃CH₃ | 0.0000885001 |

Micro-GC Analysis during durability (1A ·
cm⁻²; 200 °C and 10% H₂

| | |
|---|---|
| @ 65 hours | @ 99 hours |

| | | | |
|---|---|---|---|
| H₂ | 0.995853522 | H2 | 0.99416214 |
| CH₄ | 0.003843645 | CH₄ | 0.004327631 |
| N₂ | 0.0000815319 | N₂ | 0.001180263 |
| CO₂ | 0.000163064 | CO₂ | 0.000241129 |
| CH₃CH₃ | 0.000058237 | CH₃CH₃ | 0.000088837 |

### Example 4—Crosslinked Membranes

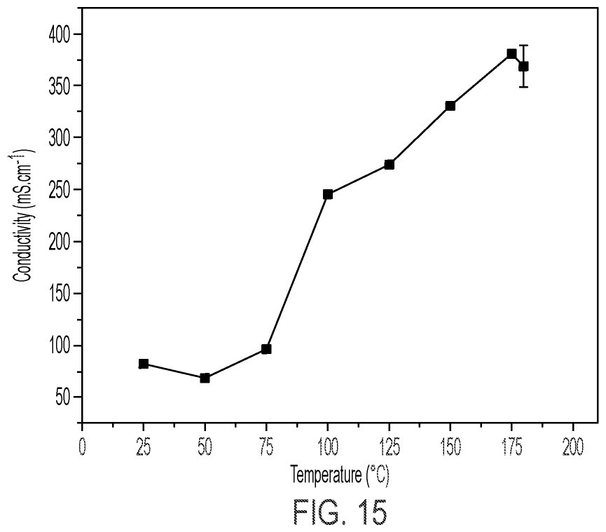

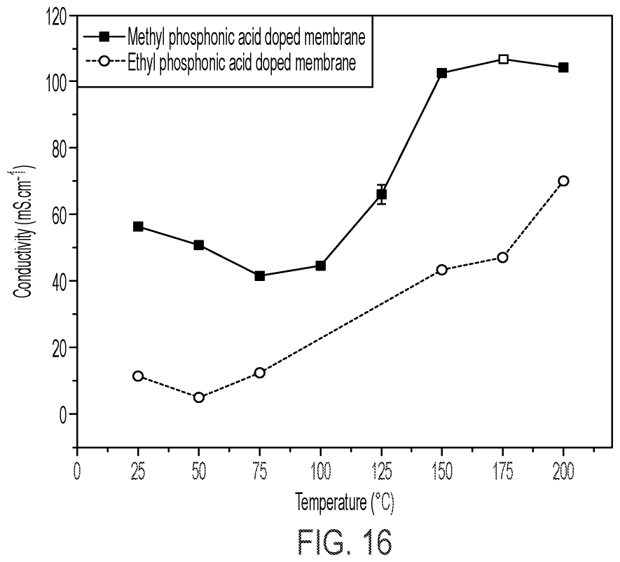

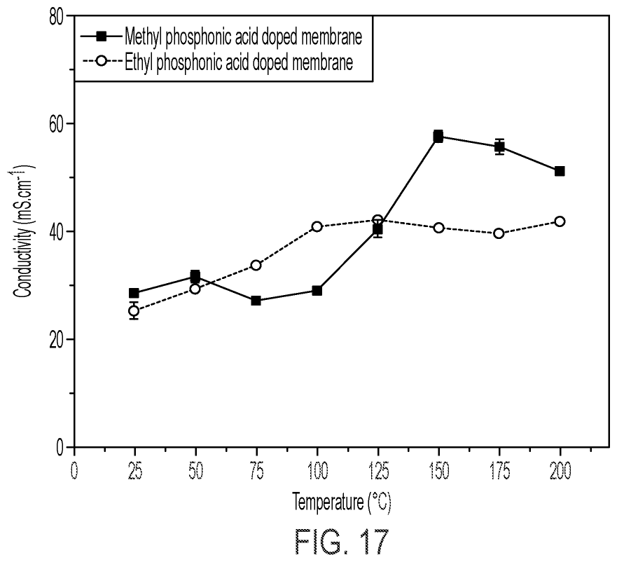

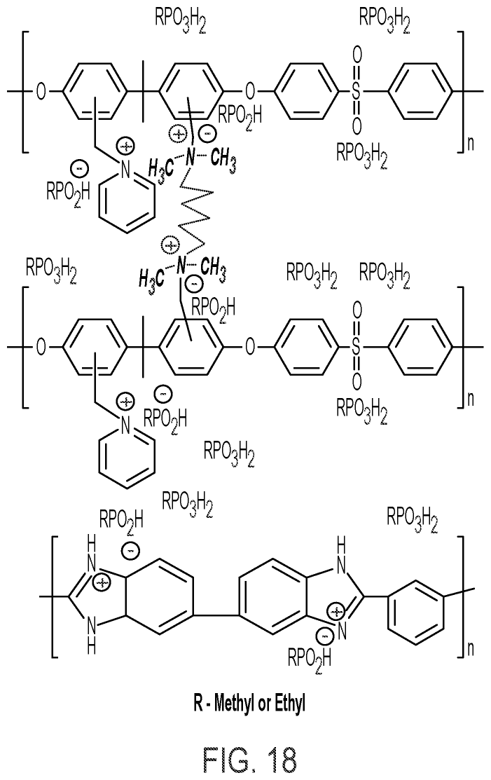

A solution containing 5 wt. % polybenzimidazole and 5 wt. % chloromethylated polysulfone) in dimethylacetamide were blended to form a uniform mixture. N,N,N,N tetramethyl hexane diamine (TMHDA) (5 mol % per mole of chloromethyl group in CMPSF) is added and immediately the mixture was drop casted on the glass plate. The membrane was maintained at 120° C. for six hours to form a crosslinked membrane. The resulting film was separated from the glass plate and immersed in a pyridine solution (1 M in reagent alcohol) for 16 hours at 40° C. The crosslinked membrane was washed and rinsed to remove excess pyridine, and then immersed in 85 wt. % H₃PO₄ for 6 hours at 120° C. The crosslinked membrane was blotted dry and used without further purification. The conductivity of this membrane is depicted in FIG. 14. FIG. 15-17 depict the conductivity of other high temperature polymer electrolyte membranes prepared according to analogous procedures.

The compositions and methods of the appended claims are not limited in scope by the specific compositions and methods described herein, which are intended as illustrations of a few aspects of the claims and any compositions and methods that are functionally equivalent are intended to fall within the scope of the claims. Various modifications of the compositions and methods in addition to those shown and described herein are intended to fall within the scope of the appended claims. Further, while only certain representative compositions and method steps disclosed herein are specifically described, other combinations of the compositions and method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated. The term “comprising” and variations thereof as used herein is used synonymously with the term “including” and variations thereof and are open, non-limiting terms. Although the terms “comprising” and “including” have been used herein to describe various embodiments, the terms “consisting essentially of” and “consisting of” can be used in place of “comprising” and “including” to provide for more specific embodiments of the invention and are also disclosed. Other than in the examples, or where otherwise noted, all numbers expressing quantities of ingredients, reaction conditions, and so forth used in the specification and claims are to be understood at the very least, and not as an attempt to limit the application of the doctrine of equivalents to the scope of the claims, to be construed in light of the number of significant digits and ordinary rounding approaches.

1. A crosslinked polysulfone network comprising repeating units having the formula: 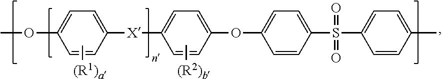
wherein
X′ is selected from null, O, C(═O), C(CH₃)₂, or C(CF₃)₂;
n′ is 0 or 1;
a′ and b′ are in each case independently selected from 0, 1, 2, 3, or 4;
R¹ and R² are in each case methylene substituted by halo or a cationic nitrogen group, for example, N(C₁₋₆ alkyl)₃, N-heterocyclyl, or N-heteroaryl;
wherein at least one R¹ or R² group comprises a cationic nitrogen group;
wherein at least one R¹ or R² group is a crosslinking group covalently bonded to a separate polysulfone monomer unit.

2. The crosslinked polysulfone network according to claim 1, wherein a′ and b′ are in each case independently selected from 0, 1, or 2.

3. The crosslinked polysulfone network according claim 1, wherein at least one of R¹ or R² is a cationic group having the formula: 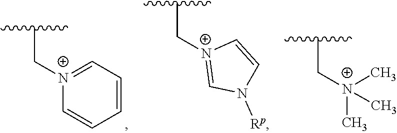
wherein
R^{p6} is a C₁₋₃ alkyl group.

4. (canceled)

5. The crosslinked polysulfone network according claim 1, wherein at least one of R¹ or R² is a group having the formula: 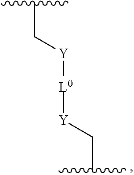
wherein L⁰ is null or C₁₋₁₂ alkylene, and Y is in each case independently selected from O, S, NH₂, HN(C₁₋₃ alkyl), N(C₁₋₃ alkyl)₂, heterocyclyl, or heteroaryl.

6. The crosslinked polysulfone network according to claim 5, wherein at least one of R¹ or R² is a group having the formula: 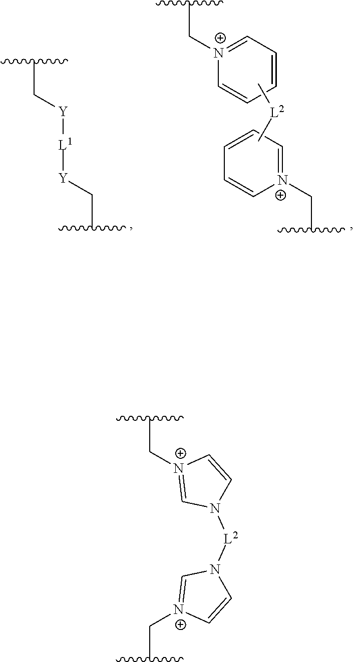
wherein L¹ is a C₂₋₁₂ alkylene group and L² is null or a C₁₋₁₂ alkylene group; and
Y is O, [NH₂]⁺, [NH(CH₃)]⁺, or [N(CH₃)₂]⁺.

7. The crosslinked polysulfone network according claim 6, wherein at least one of R¹ or R² is a group having the formula:

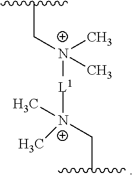

8. (canceled)

9. The crosslinked polysulfone network according to claim 1, wherein the average value of a′+b′ is from 0.8-2.2.

10. The crosslinked polysulfone network according to claim 1, wherein from 1%-20% of the R¹ and R² groups comprise a crosslinking group.

11. (canceled)

12. The crosslinked polysulfone network according to claim 1, wherein R¹ and R² are independently selected from:

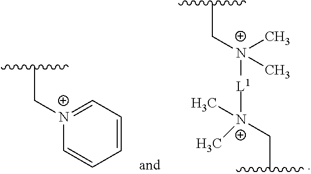

13. The crosslinked polysulfone network according to claim 1, prepared by a process comprising combining a chloromethylated polysulfone with a crosslinking agent, followed by reacting the crosslinked product with tertiary amine, N-heterocycle or N-heteroaromatic compound.

14. (canceled)

15. The crosslinked polysulfone according to claim 13, prepared by drop casting a mixture comprising an uncrosslinked polysulfone having the formula: 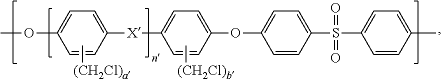
and a crosslinking compound, followed by reacting the crosslinked product with tertiary amine, N-heterocycle or N-heteroaromatic compound.

16. (canceled)

17. The crosslinked polysulfone network according to claim 13, wherein the mixture comprises crosslinking compound in an amount 1%-20% relative to the mass of the uncrosslinked polysulfone and crosslinking compound.

18. A crosslinked polybenzimidazole network, comprising a polybenzimidazole crosslinked with a polyvinyl benzyl chloride, wherein the polybenzimidazole in present in an amount from 60-85 wt. %, relative to the combined mass of the linear benzimidazole and poly(vinylbenzylchloride).

19. (canceled)

20. The crosslinked polybenzimidazole network according claim 18, wherein the polybenzimidazole network is obtained by drop casting a mixture comprising linear polybenzimidazole with poly(vinylbenzylchloride), followed by reacting the crosslinked product with tertiary amine, N-heterocycle or N-heteroaromatic compound.

21. The crosslinked polybenzimidazole network according to claim 20, wherein the linear polybenzimidazole comprises poly[4,4-diphenylether-5,5′-bisbenzimidazole], or poly[2,2′-(m-phenylene)-5,5′-bisbenzimidazole].

22. The crosslinked polybenzimidazole network according claim 20, wherein the mixture comprises the linear polybenzimidazole in an amount from 60-85 wt. %, relative to the combined mass of the linear benzimidazole and poly(vinylbenzylchloride).

23. The crosslinked network according to claim 20, wherein the tertiary amine, N-heterocycle or N-heteroaromatic compound comprises pyridine, N-alkylimidazole, trimethyl amine, triethylamine, diethylisopropylamine, quinuclidine, 1,4-diazabicyclo[2.2.2]octane, or a combination thereof.

24. (canceled)

25. A membrane, comprising the crosslinked network according to claim 1 and a strong acid.

26. The membrane according to claim 25, wherein the strong acid comprises a phosphoric acid, phosphonic acid, sulfuric acid, sulfonic acid, nitric acid, or a combination thereof.

27. The membrane according to claim 26, wherein the strong acid comprises a phosphonic acid having the formula R^{a}—PO₃H₂, wherein R^{a} is a C₁₋₃ alkyl group.

28-30. (canceled)
